(19) United States
(12) Patent Application Publication
(10) Pub. No.: US 2024/0073382 A1
(43) Pub. Date: Feb. 29, 2024

(54) OPTICAL DEVICE, PROJECTION TYPE DISPLAY APPARATUS, AND OPTICAL SYSTEM

(71) Applicant: FUJIFILM Corporation, Tokyo (JP)

(72) Inventors: Yukiko NAGATOSHI, Saitama (JP); Taku FURUBAYASHI, Saitama (JP)

(73) Assignee: FUJIFILM Corporation, Tokyo (JP)

(21) Appl. No.: 18/447,674

(22) Filed: Aug. 10, 2023

(30) Foreign Application Priority Data
Aug. 30, 2022 (JP) 2022-137265

(51) Int. Cl. H04N 9/31; G02B 7/14

(52) U.S. Cl. CPC H04N 9/317; G02B 7/14; H04N 9/3197

(57) ABSTRACT

The optical device projects an image, which is displayed on an image display surface on a reduction side, to a magnification side. The optical device includes: a first optical system; and a second optical system, in order from the magnification side to the reduction side along an optical path. The first optical system is an image forming optical system which is not telecentric on the reduction side, the second optical system is telecentric on the reduction side, the first optical system is housed in a first lens barrel, and the second optical system is housed in a second lens barrel, and an optical system on the optical path from a surface closest to the magnification side in the first optical system to a surface closest to the reduction side in the second optical system is shift-able with respect to the image display surface.

### CROSS-REFERENCE TO RELATED APPLICATIONS

This application claims priority from Japanese Patent Application No. 2022-137265, filed on Aug. 30, 2022, the entire disclosure of which is incorporated herein by reference.

### BACKGROUND OF THE INVENTION

### Technical Field

The technique of the present disclosure relates to an optical device, a projection type display apparatus, and an optical system.

### Related Art

JP2013-20231A describes a projection optical system and a projector comprising the projection optical system.

### SUMMARY

A commercially available lens, such as an interchangeable lens for a digital camera, is cheaper than a normal projection lens used in a projection type display apparatus, and lenses having various specifications are easily available. Therefore, in a case where a commercially available lens can be used as an interchangeable lens for projection, a projection lens having the above-mentioned advantages can be realized.

Meanwhile, there has been a strong demand for a projection type display apparatus having a function (hereinafter, referred to as a lens shift function) capable of adjusting a position of a projected image on a screen by shifting a projection lens with respect to an image display element. In order for the projection type display apparatus to have the lens shift function, it is necessary for the projection lens to have a telecentric configuration.

However, since most of the commercially available lenses as described above are not telecentric, it is not possible to realize a projection type display apparatus having a lens shift function even in a case where the lenses are mounted on the projection type display apparatus as they are.

The present disclosure has been made in view of the above circumstances, and has an object to provide an optical device having a lens shift function while using a non-telecentric lens, a projection type display apparatus comprising the optical device, and an optical system used in the optical device.

According to a first aspect of the present disclosure, there is provided an optical device that projects an image, which is displayed on an image display surface on a reduction side, to a magnification side. The optical device comprises: a first optical system; and a second optical system, in order from the magnification side to the reduction side along an optical path. The first optical system is an image forming optical system which is not telecentric on the reduction side, the second optical system is telecentric on the reduction side, the first optical system is housed in a first lens barrel, and the second optical system is housed in a second lens barrel, and an optical system on the optical path from a surface closest to the magnification side in the first optical system to a surface closest to the reduction side in the second optical system is shift-able with respect to the image display surface.

According to a second aspect of the present disclosure, in the first aspect, the optical device is configured as a coaxial system in which the first optical system and the second optical system have a common first optical axis.

According to a third aspect of the present disclosure, in the optical device in the second aspect, the first optical system is configured to be interchangeable.

According to a fourth aspect of the present disclosure, in the optical device in the second aspect, the optical system between the first optical system and the image display surface is only the second optical system, and an intermediate image is formed closer to the reduction side than the first optical system.

According to a fifth aspect of the present disclosure, in the optical device in the fourth aspect, the second optical system includes a group that moves by changing a spacing between adjacent groups during magnification change.

According to a sixth aspect of the present disclosure, in the optical device in the second aspect, the optical system between the first optical system and the image display surface is only the second optical system, and a principal ray with a maximum angle of view incident on the optical device from the image does not intersect with the first optical axis at a position closer to the reduction side than a surface closest to the reduction side in the first optical system.

According to a seventh aspect of the present disclosure, in the second aspect, the optical device further comprises: a third optical system on the optical path closer to the reduction side than the second optical system. The third optical system is a coaxial system having a second optical axis, the first optical axis and the second optical axis are parallel to each other, and an intermediate image is formed closer to the reduction side than the first optical system.

According to an eighth aspect of the present disclosure, in the optical device in the seventh aspect, the intermediate image is formed between a surface closest to the magnification side in the second optical system and the surface closest to the reduction side in the second optical system.

According to a ninth aspect of the present disclosure, in the optical device in the seventh aspect, the third optical system is housed in a third lens barrel, and the second optical system is configured to be interchangeable.

According to a tenth aspect of the present disclosure, in the optical device in the seventh aspect, the third optical system includes a group that moves by changing a spacing between adjacent groups during magnification change.

According to an eleventh aspect of the present disclosure, in the optical device in the first aspect, assuming that a combined lateral magnification of an entire optical system between the first optical system and the image display surface is β, where β is a value in a case where the magnification side is an object side and the reduction side is an image side, and β is a value at a wide angle end in a case where the optical device includes a variable magnification optical system, Conditional Expression (1) is satisfied, which is represented by

0.25<|β|<2 (1).

According to a twelfth aspect of the present disclosure, in the optical device in the first aspect, assuming that an on-axis ray of which an angle θ1 with an optical axis satisfies sin θ1=0.1 in an air spacing adjacent to the reduction side in the second optical system is a first on-axis ray, an angle between the first on-axis ray and the optical axis in an air spacing adjacent to the magnification side in the second optical system is θ, a lateral magnification of the second optical system is β2, where β2 is a value in a case where the magnification side is an object side and the reduction side is an image side, a total number of lenses included in the second optical system is k, a natural number from 1 to k is i, a refractive index of an i-th lens of the second optical system at a d line from the magnification side is Ni, a focal length of the i-th lens of the second optical system from the magnification side is fi, and a distance on the optical axis from a surface closest to the magnification side in the second optical system to the surface closest to the reduction side in the second optical system is DU2, where θ, β2, and DU2 are values at a wide angle end in a case where the optical device includes a variable magnification optical system, Conditional Expressions (2) and (3) are satisfied, which are represented by

$$\vert \{ sin \vert θ \vert / ( \vert β2 \vert \times 0.1 ) - 1 \} \times 100 \vert < 0.2 , \qquad ( 2 )$$

$$and$$

$$DU 2 \times \vert {\sum }_{i = 1}^{k} ( \frac{1}{Ni \times fi} ) \vert < 1. \qquad ( 3 )$$

According to a thirteenth aspect of the present disclosure, in the optical device in the first aspect, assuming that a maximum image height on the reduction side in the second optical system is Ymax, a distance to a sagittal image plane at the maximum image height of the second optical system with respect to a paraxial image formation position on the reduction side in the second optical system as an origin in a direction of optical axis is Sr, and a distance to a tangential image plane at the maximum image height of the second optical system with respect to the paraxial image formation position on the reduction side in the second optical system as an origin in the direction of optical axis is Tr, where a sign of each distance of Sr and Tr on the magnification side from each origin is negative and a sign of each distance of Sr and Tr on the reduction side from each origin is positive, and Sr, Tr, and Ymax are values at a wide angle end in a case where the optical device includes a variable magnification optical system, Conditional Expressions (4) and (5) are satisfied, which are represented by

−10<{(Sr+Tr)/2}×1000/Ymax<20 (4), and

|Sr−Tr|×1000/Ymax<30 (5).

According to a fourteenth aspect of the present disclosure, in the eleventh aspect, the optical device that satisfies Conditional Expression (1-1), which is represented by

0.4<|β|<1.5 (1-1).

According to a fifteenth aspect of the present disclosure, in the twelfth aspect, the optical device that satisfies Conditional Expression (2-1), which is represented by

0≤|{sin|θ|/(β2|×0.1)−1}×100|<0.1 (2-1).

According to a sixteenth aspect of the present disclosure, in the twelfth aspect, the optical device that satisfies Conditional Expression (3-1), which is represented by

$$0 ≦ DU 2 \times \vert {{\sum }_{i = 1}}^{k} ( \frac{1}{Ni \times fi} ) \vert < 0.5 . \qquad ( 3 - 1 )$$

According to a seventeenth aspect of the present disclosure, in the thirteenth aspect, the optical device that satisfies Conditional Expression (4-1), which is represented by

0<{(Sr+Tr)/2}×1000/Ymax<10 (4-1).

According to an eighteenth aspect of the present disclosure, in the thirteenth aspect, the optical device that satisfies Conditional Expression (5-1), which is represented by

0<|Sr−Tr|×1000/Ymax<20 (5-1).

According to a nineteenth aspect of the present disclosure, there is provided a projection type display apparatus comprising: a light valve that outputs an image; and the optical device according to any one of the first to eighteenth aspects.

According to a twentieth aspect of the present disclosure, there is provided an optical system incorporated in an optical device that projects an image, which is displayed on an image display surface on a reduction side, to a magnification side. The optical system is disposed on an optical path on the reduction side of an image forming optical system which is not telecentric on the reduction side and is housed in a first lens barrel, the optical system is telecentric on the reduction side, the optical system is housed in a second lens barrel, and the optical system is shift-able integrally with the image forming optical system with respect to the image display surface.

In the present specification, it should be noted that the term “consists of” means that the lens may include not only the above-mentioned components but also lenses substantially having no powers, optical elements, which are not lenses, such as a stop, a mask, a filter, a cover glass, a plane minor, and a prism, and mechanism parts such as a lens flange, a lens barrel, an imaging element, and a camera shaking correction mechanism.

The “lens group” in the present specification may include optical elements other than the lens such as a stop, a mask, a filter, a cover glass, a plane mirror, and a prism in addition to the lens. The term “lens group” in the present specification is not limited to a configuration consisting of a plurality of lenses, but may be a configuration consisting of only one lens. The “focal length” used in a conditional expression is a paraxial focal length. Unless otherwise specified, the “distance on the optical axis” used in Conditional Expression is considered as a geometrical distance.

The “d line”, “C line”, and “F line” described in the present specification are bright lines, the wavelength of the d line is 587.56 nm (nanometers), the wavelength of the C line is 656.27 nm (nanometers), and the wavelength of the F line is 486.13 nm (nanometers).

According to the present disclosure, it is possible to provide an optical device having a lens shift function while using a non-telecentric lens, a projection type display apparatus comprising the optical device, and an optical system used for the optical device.

### BRIEF DESCRIPTION OF THE DRAWINGS

FIG. 1 is a conceptual diagram showing a configuration of an optical device according to a first embodiment.

FIG. 2 is a conceptual diagram for explaining angles θ and θ1.

FIG. 3 is a conceptual diagram showing a configuration of an optical device according to a second embodiment.

FIG. 4 is a conceptual diagram showing a configuration of an optical device according to a third embodiment.

FIG. 5 is a cross-sectional view showing a configuration and luminous flux of an optical device of Example 1.

FIG. 6 is a diagram of aberrations of the optical device of Example 1.

FIG. 7 is a diagram of aberrations of only the second optical system of the optical device of Example 1.

FIG. 8 is a cross-sectional view showing a configuration and luminous flux of an optical device of Example 2.

FIG. 9 is a diagram of aberrations of the optical device of Example 2.

FIG. 10 is a diagram of aberrations of only a second optical system of the optical device of Example 2.

FIG. 11 is a cross-sectional view showing a configuration and luminous flux of an optical device of Example 3.

FIG. 12 is a diagram of aberrations of the optical device of Example 3.

FIG. 13 is a diagram of aberrations of only the second optical system of the optical device of Example 3.

FIG. 14 is a cross-sectional view showing a configuration and luminous flux of an optical device of Example 4-1.

FIG. 15 is a diagram of aberrations of the optical device of Example 4-1.

FIG. 16 is a diagram of aberrations of only the second optical system of the optical device of Example 4-1.

FIG. 17 is a cross-sectional view showing a configuration and luminous flux of an optical device of Example 4-2.

FIG. 18 is a diagram of aberrations of the optical device of Example 4-2.

FIG. 19 is a diagram of aberrations of only the second optical system of the optical device of Example 4-2.

FIG. 20 is a cross-sectional view showing a configuration and luminous flux of an optical device of Example 4-3.

FIG. 21 is a diagram of aberrations of the optical device of Example 4-3.

FIG. 22 is a diagram of aberrations of only the second optical system of the optical device of Example 4-3.

FIG. 23 is a cross-sectional view showing a configuration and luminous flux of an optical device of Example 5.

FIG. 24 is a diagram of aberrations of the optical device of Example 5.

FIG. 25 is a diagram of aberrations of only the second optical system of the optical device of Example 5.

FIG. 26 is a cross-sectional view showing a configuration and luminous flux of an optical device of Example 6.

FIG. 27 is a diagram of each aberrations of the optical device of Example 6.

FIG. 28 is a diagram of aberrations of only the second optical system of the optical device of Example 6.

FIG. 29 is a cross-sectional view showing a configuration and luminous flux of an optical device according to a modification example of Example 6.

FIG. 30 is a cross-sectional view showing a configuration and luminous flux of an optical device of Example 7.

FIG. 31 is a diagram of aberrations of the optical device of Example 7.

FIG. 32 is a diagram of aberrations of only the second optical system of the optical device of Example 7.

FIG. 33 is a schematic configuration diagram of a projection type display apparatus according to an embodiment.

FIG. 34 is a schematic configuration diagram of a projection type display apparatus according to another embodiment.

FIG. 35 is a schematic configuration diagram of a projection type display apparatus according to still another embodiment.

### DESCRIPTION OF EMBODIMENTS

Hereinafter, embodiments of the present disclosure will be described with reference to the accompanying drawings.

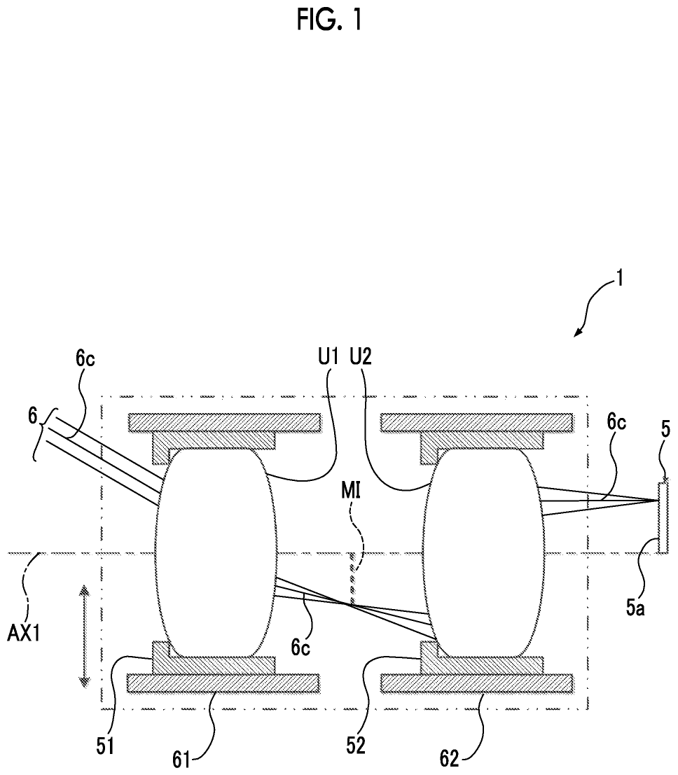

FIG. 1 shows a conceptual diagram of a configuration of an optical device 1 according to an embodiment of the present disclosure. FIG. 1 is a conceptual diagram showing a configuration of an optical device 1 according to a first embodiment of the present disclosure. First, a basic configuration and a preferable configuration that can be added to the basic configuration will be described with reference to FIG. 1. The basic configuration is a configuration common to the first embodiment, a second embodiment, and a third embodiment of the present disclosure to be described later. In FIG. 1, the left side is set as the magnification side, and the right side is set as the reduction side.

The optical device 1 is mounted on, for example, a projection type display apparatus, and projects an image displayed on an image display surface 5a on the reduction side onto a screen, which is not shown in the drawing, on the magnification side. The image display surface 5a is a surface on which an image, which is output by an image display element 5 such as a liquid crystal display element or a digital micromirror device (DMD: registered trademark), is displayed. In the projection type display apparatus, the image display element 5 is also called a light valve. Although there are multiple luminous fluxes emitted from the image display surface 5a, only luminous flux 6 with the maximum angle of view is shown in FIG. 1. An image, which is displayed on the image display surface 5a, and a projected image, which is formed on the screen by the optical device 1, are optically conjugated. It should be noted that, in the present specification, the “screen” means an object on which a projected image formed by the optical device 1 is projected. The screen may be not only a dedicated screen but also a wall surface of a room, a floor surface, a ceiling surface, an outer wall surface of a building, or the like.

Further, in the present specification, the term “magnification side” means the screen side on the optical path, and the “reduction side” means the image display surface 5a side on the optical path. In the present specification, the terms “magnification side” and “reduction side” are determined along the optical path, and this point is the same in a case of the optical system forming the deflected optical path. In the following description, in order to avoid making the description redundant, the phrase “in order from the magnification side to the reduction side along the optical path” may be described as “in order from the magnification side to the reduction side”.

The optical device 1 includes a first optical system U1 and a second optical system U2, in order from the magnification side to the reduction side along the optical path. Each of the first optical system U1 and the second optical system U2 includes at least one lens. The first optical system U1 and the second optical system U2 may include a plurality of lenses. However, FIG. 1 conceptually shows the first optical system U1 and the second optical system U2.

The first optical system U1 is an image forming optical system. As the first optical system U1, for example, it is possible to use a commercially available lens such as an interchangeable lens for a digital camera. Such a commercially available lens has an advantage that the lens is inexpensive, has various specifications, and is easily available.

In the optical device 1, the first optical system U1 is not telecentric on the reduction side, and the second optical system U2 is telecentric on the reduction side. As shown in FIG. 1, the phrase “the first optical system U1 is not telecentric on the reduction side” indicates a state where a principal ray 6c emitted from the first optical system U1 to the reduction side is not parallel to an optical axis AX1. As shown in FIG. 1, the phrase “the second optical system U2 is telecentric on the reduction side” indicates, a state where the principal ray 6c emitted from the second optical system U2 to the reduction side is parallel to the optical axis AX1. Here, the term “parallel” in the present specification includes not only perfectly parallel but also substantially parallel including an allowable error. The allowable error is in a range in which the inclination of the principal ray 6c with respect to the optical axis AX1 is preferably in a range of −5 degrees or more and +5 degrees or less, and more preferably in a range of −3 degrees or more and +3 degrees or less. In an optical system in which the principal ray 6c is not determined, the angle bisector of the maximum ray on the upper side and the maximum ray on the lower side of the luminous flux may be used as a substitute for the principal ray 6c.

The optical device 1 is configured such that the optical system on the optical path from the surface closest to the magnification side in the first optical system U1 to the surface closest to the reduction side in the second optical system U2 can be integrally shifted with respect to the image display surface 5a. For example, the first optical system U1 to the second optical system U2 can be shifted integrally in a direction perpendicular to the optical axis AX1. The frame of the two-point chain line surrounding the first optical system U1 and the second optical system U2 and the vertical arrow in FIG. 1 indicate an operation of the shift. By shifting in such a manner, a position of the projected image on the screen can be adjusted.

The second optical system U2 is configured to be telecentric on the reduction side. By performing the shift as described above, the optical device 1 is able to have a lens shift function while using the first optical system U1 not telecentric on the reduction side. In a configuration in which the second optical system U2 is configured to be not telecentric on the reduction side, in a case where the shift is performed, a part of the luminous flux for image forming is blocked, so-called vignetting may occur. In a state where vignetting occurs, a favorable projected image cannot be obtained, and it cannot be said that the lens shift function is substantially provided. In contrast, in the optical device 1, since the second optical system U2 is telecentric on the reduction side, even in a case where the shift is performed as described above, vignetting does not occur and a favorable projected image can be obtained.

In addition, FIG. 1, the first optical system U1 and the second optical system U2 are continuously disposed. However, in the present disclosure, an optical member, which does not have a power between the first optical system U1 and the second optical system U2, may be disposed. Examples of the optical member which does not have a power include a plane mirror, a filter, a cover glass, and a prism. In a case where an optical member which does not have a power is disposed between the first optical system U1 and the second optical system U2, “the above-mentioned optical system on the optical path from the surface closest to the magnification side in the first optical system U1 to the surface closest to the reduction side in the second optical system U2” also includes an optical member which does not have a power between the first optical system U1 and the second optical system U2. Further, the above-mentioned integral shift” means that the same amount of shift is performed in the same direction simultaneously.

Further, although only the first optical system U1 and the second optical system U2 are shown as the optical system in FIG. 1, in the basic configuration of the present disclosure, as in the third embodiment to be described later, the optical system may include a separate optical system closer to the reduction side than the second optical system U2.

In the optical device 1, the first optical system U1 and the second optical system U2 are housed in different lens barrels. In FIG. 1, a lens barrel 61 houses the first optical system U1, and a lens barrel 62 houses the second optical system U2. The lens barrel 61 corresponds to the “first lens barrel” according to the technique of the present disclosure, and the lens barrel 62 corresponds to the “second lens barrel” according to the technique of the present disclosure. In a case where the first optical system U1 includes a lens, a lens frame 51 is provided in the lens barrel 61, and each lens or each lens group of the first optical system U1 is disposed in the lens frame 51. In a case where a plurality of lenses or lens groups of the first optical system U1 are present, a plurality of lens frames 51 are also present as many as the number of lenses or lens groups. The lens barrel 61 is a member that collectively houses the lens frames 51 and holds the entire first optical system U1. In a similar manner, in a case where the second optical system U2 includes a lens, a lens frame 52 is provided in the lens barrel 62, and each lens or each lens group of the second optical system U2 is disposed in the lens frame 52. In a case where a plurality of lenses or lens groups of the second optical system U2 are present, a plurality of lens frames 52 are also present as many as the number of lenses or lens groups. The lens barrel 62 is a member that collectively houses the lens frames 52 and holds the entire second optical system U2. The lens barrel 61 and the lens barrel 62 are separate members different from each other. Each of the lens barrel 61 and the lens barrel 62 is a member which houses individual optical systems. In addition, it is also possible to remove the lens frames 51 and 52 by forming the lens barrels 61 and 62 to directly hold each lens or each lens group.

It is preferable that the first optical system U1 is configured to be interchangeable. In such a case, an optical system having various specifications can be used as the first optical system U1. Therefore, by replacing the first optical system U1, a projection type display apparatus that can cope with various conditions and environments can be realized.

It is preferable that the second optical system U2 is configured to be interchangeable. In such a case, even in a case where various optical systems having different pupil positions are used as the first optical system U1, the first optical system U1 can be replaced with the second optical system U2 corresponding to each pupil position.

In the optical device 1, since different lens barrels house the first optical system U1 and the second optical system U2, the first optical system U1 and the second optical system U2 can be configured to be replaced independently and to be highly convenient.

It is preferable that the first optical system U1 and the second optical system U2 are coaxial systems having a common optical axis AX1. In such a case, there is an advantage in simplifying the configuration.

Assuming that a combined lateral magnification of the entire optical system between the first optical system U1 and the image display surface 5a is β, it is preferable that the optical device 1 satisfies Conditional Expression (1). β is a value in a case where the magnification side is the object side and the reduction side is the image side. That is, in a case of performing ray tracing, β is calculated with a position of an image formed by the first optical system U1 as the object position and the image display surface 5a as the image position. β is a value at the wide angle end in a case where the optical device 1 includes a variable magnification optical system. By not allowing the corresponding value of Conditional Expression (1) to be equal to or less than the lower limit thereof, there is an advantage in ensuring the shift amount and achieving reduction in size. By not allowing the corresponding value of Conditional Expression (1) to be equal to or greater than the upper limit thereof, the image formed by the second optical system U2 is prevented from becoming excessively small as compared with the image displayed on the image display surface 5a, and the spatial frequency of the resolution necessary for the first optical system U1 is prevented from becoming excessively high. As a result, there is an advantage in ensuring favorable performance. In order to obtain more favorable characteristics, it is more preferable that the optical device 1 satisfies Conditional Expression (1-1).

0.25<|β|<2 (1)

0.4<|β|<1.5 (1-1).

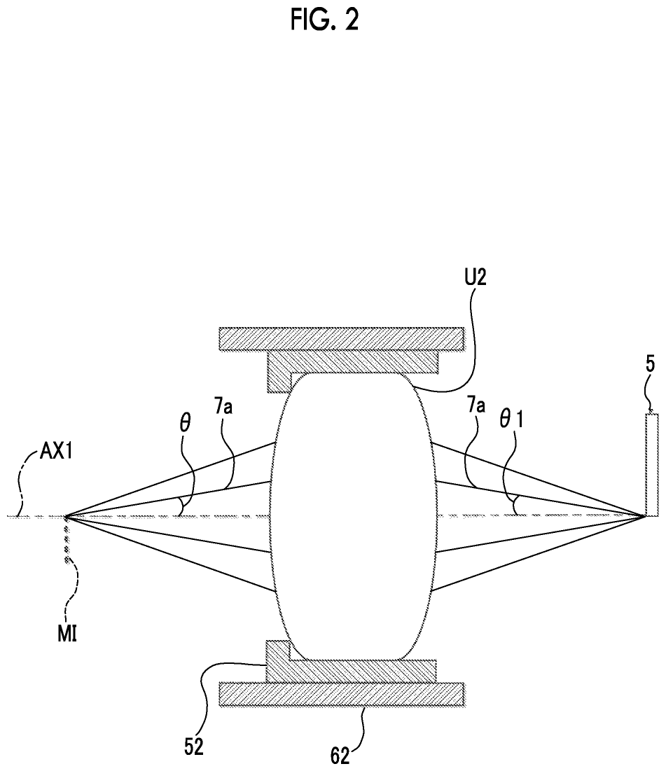

Further, it is preferable that the optical device 1 satisfies Conditional Expression (2). FIG. 2 shows a diagram for explaining a symbol used in Conditional Expression (2). FIG. 2 is a conceptual diagram, and θ and θ1 in FIG. 2 are not necessarily accurate angles. In Conditional Expression (2), an on-axis ray where the angle θ1 with the optical axis AX1 at the air spacing adjacent to the reduction side in the second optical system U2 satisfies sin θ1=0.1 is set as a first on-axis ray 7a. In addition, it is assumed that an angle between the first on-axis ray 7a and the optical axis AX1 in the air spacing adjacent to the magnification side in the second optical system U2 is θ. It is assumed that a lateral magnification of the second optical system U2 is β2. β2 is a value in a case where the magnification side is the object side and the reduction side is the image side. By not allowing the corresponding value of Conditional Expression (2) to be equal to or greater than the upper limit thereof, it is possible to suppress an increase in amount of violation of the sinusoidal condition. As a result, there is an advantage in ensuring resolution performance in the vicinity of the optical axis. In order to obtain more favorable characteristics, it is more preferable that the optical device 1 satisfies Conditional Expression (2-1). It is clear that the lower limit of Conditional Expression (2-1) is “0” since the corresponding value of Conditional Expression (2-1) is an absolute value.

|{sin|θ|/(|β2|×0.1}×100|<0.2(2)

0≤|{sin|θ|/(β2|×0.1)−1}×100|<0.1 (2-1).

Further, it is preferable that the optical device 1 satisfies Conditional Expression (3). In Conditional Expression (3), it is assumed that a total number of lenses included in the second optical system U2 is k. It is assumed that a natural number from 1 to k is i. It is assumed that a refractive index of an i-th lens of the second optical system U2 from the magnification side at the d line is Ni. It is assumed that a focal length of the i-th lens of the second optical system from the magnification side U2 is fi. It is assumed that a distance on the optical axis from a surface closest to the magnification side in the second optical system U2 to the surface closest to the reduction side in the second optical system U2 is DU2. θ, β2, and DU2 are values at the wide angle end in a case where the optical device 1 includes the variable magnification optical system. By not allowing the corresponding value of Conditional Expression (3) to be equal to or greater than the upper limit thereof, it is easy to correct the field curvature. Further, there is an advantage in ensuring the resolution performance in a range from the vicinity of the image height of 50% of the maximum image height to the edge part of the image forming region. In order to obtain more favorable characteristics, it is more preferable that the optical device 1 satisfies Conditional Expression (3-1). It is clear that the lower limit of Conditional Expression (3-1) is “0” since the corresponding value of Conditional Expression (3-1) is a product of the distance and the absolute value.

$$DU 2 \times \vert {\sum }_{i = 1}^{k} ( \frac{1}{Ni \times fi} ) \vert < 1 \qquad ( 3 )$$

$$0 ≦ DU 2 \times \vert {\sum }_{i = 1}^{k} ( \frac{1}{Ni \times fi} ) \vert < 0.5 \qquad ( 3 - 1 )$$

It is preferable that the optical device 1 satisfies Conditional Expressions (2) and (3) simultaneously. In a case where a commercially available lens of which performance is ensured by correcting various aberrations independently is used as the first optical system U1, it is desired that the performance of the second optical system U2 is also ensured independently. By simultaneously satisfying Conditional Expressions (2) and (3), it is possible to ensure the performance of the second optical system U2 alone. It is more preferable that the optical device 1 satisfies Conditional Expressions (2) and (3) simultaneously, and then satisfies at least one of Conditional Expression (2-1) or (3-1).

Further, it is preferable that the optical device 1 satisfies Conditional Expression (4). In Conditional Expression (4), it is assumed that a maximum image height on the reduction side in the second optical system U2 is Ymax. It is assumed that a distance to a sagittal image plane at the maximum image height of the second optical system U2 with respect to a paraxial image formation position on the reduction side in the second optical system U2 as an origin in a direction of optical axis AX1 is Sr. It is assumed that a distance to a tangential image plane at the maximum image height of the second optical system U2 with respect to the paraxial image formation position on the reduction side in the second optical system U2 as an origin in the direction of optical axis AX1 is Tr. A sign of each distance of Sr and Tr on the magnification side from each origin is negative and a sign of each distance of Sr and Tr on the reduction side from each origin is positive. Sr, Tr, and Ymax are values at the wide angle end in a case where the optical device 1 includes the variable magnification optical system. By satisfying Conditional Expression (4), an increase in field curvature in the edge part of the image forming region can be suppressed. It is easy to ensure the performance in the edge part of the image forming region. In a commercially available lens such as an interchangeable lens for a digital camera, aberration correction is generally performed by providing a cover glass of an imaging element, and image forming performance is ensured. In a case where such a commercially available lens is the first optical system U1, the allowable amount of the corresponding value of Conditional Expression (4) is smaller in the negative direction. Therefore, in a case where the lower and upper limits of Conditional Expression (4) are set as follows, there is an advantage in ensuring the performance. In order to obtain more favorable characteristics, it is more preferable that the optical device 1 satisfies Conditional Expression (4-1).

−10<{(Sr+Tr)/2}×1000/Ymax<20 (4), and

0<{(Sr+Tr)/2}×1000/Ymax<10 (4-1).

Further, it is preferable that the optical device 1 satisfies Conditional Expression (5). Sr, Tr, and Ymax of Conditional Expression (5) are the same as Sr, Tr, and Ymax of Conditional Expression (4). By not allowing the corresponding value of Conditional Expression (5) to be equal to or greater than the upper limit thereof, it is possible to suppress an increase in astigmatism in the edge part of the image forming region. It is easy to ensure the performance in the edge part of the image forming region. In order to obtain more favorable characteristics, it is more preferable that the optical device 1 satisfies Conditional Expression (5-1). It is clear that the lower limit of Conditional Expression (5-1) is “0” since the corresponding value of Conditional Expression (5-1) is 1000 times a division between the absolute value and the maximum image height.

|Sr−Tr|×1000/Ymax<30 (5).

0<|Sr−Tr|×1000/Ymax<20 (5-1).

It is preferable that the optical device 1 satisfies Conditional Expressions (4) and (5) simultaneously. In a case where a commercially available lens of which performance is ensured by correcting various aberrations independently is used as the first optical system U1, it is desired that the performance of the second optical system U2 is also ensured independently. By satisfying Conditional Expressions (4) and (5) simultaneously, it is easy to ensure the performance of the second optical system U2 alone in the edge part of the image forming region. It is more preferable that the optical device 1 satisfies Conditional Expressions (4) and (5) simultaneously, and then satisfies at least one of Conditional Expressions (4-1) or (5-1).

Next, the first embodiment, the second embodiment, and the third embodiment of the present disclosure will be described. Each of the first embodiment, the second embodiment, and the third embodiment has the above-mentioned basic configuration. Further, it is preferable that each of the first embodiment, the second embodiment, and the third embodiment has a preferable configuration with respect to the above-mentioned basic configuration. In the following description of each embodiment, redundant description of the above-mentioned basic configuration and a preferred configuration thereof will not be repeated.

FIG. 1 shows a conceptual diagram of a configuration of the optical device 1 according to the first embodiment. In the first embodiment, the optical system between the first optical system U1 and the image display surface 5a is only the second optical system U2, and the intermediate image MI is formed closer to the reduction side than the first optical system U1. That is, the second optical system U2 has a function as a relay optical system. By providing the relay optical system closer to the reduction side than the first optical system U1, it is easy to ensure the back focal length of the optical device 1 on the reduction side. Thereby, the color synthesis prism and the like are easily disposed.

In the first embodiment, it is preferable that the second optical system U2 includes a group that moves by changing a spacing from the adjacent group during magnification change. That is, it is preferable that the second optical system U2 is a variable magnification optical system. In such a case, even in a case where the first optical system U1 is a fixed focus optical system, the size of the projected image can be easily changed, and a highly convenient apparatus can be provided. The second optical system U2 can be, for example, a zoom lens.

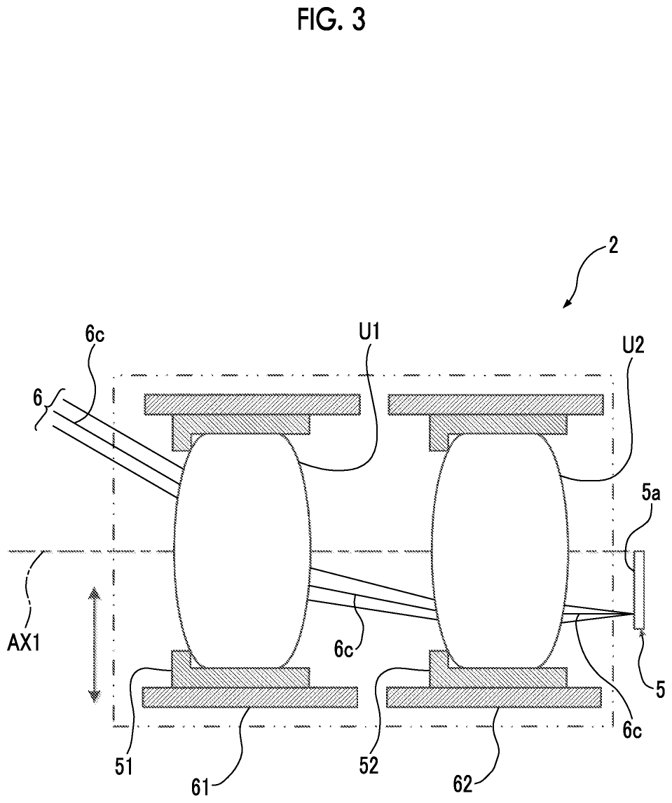

Next, the second embodiment will be described. FIG. 3 shows a conceptual diagram of a configuration of an optical device 2 according to the second embodiment of the present disclosure. The illustration method of FIG. 3 is basically the same as that of FIG. 1. The optical device 2 includes the first optical system U1 and the second optical system U2 in order from the magnification side to the reduction side along the optical path. In the second embodiment, the intermediate image MI is not formed inside the optical device 2. In the second embodiment, the optical system between the first optical system U1 and the image display surface 5a is only the second optical system U2, and is configured such that the principal ray 6c with the maximum angle of view incident on the optical device 2 from the image does not intersect with the optical axis AX1 on the reduction side with respect to the surface closest to the reduction side in the first optical system U1. According to the configuration, the reduction in size of the apparatus can be promoted by combining with the image display element 5 of a type, for which a long back focal length is not necessary, such as a single-panel-type transmissive liquid crystal panel or a self-light-emitting element panel.

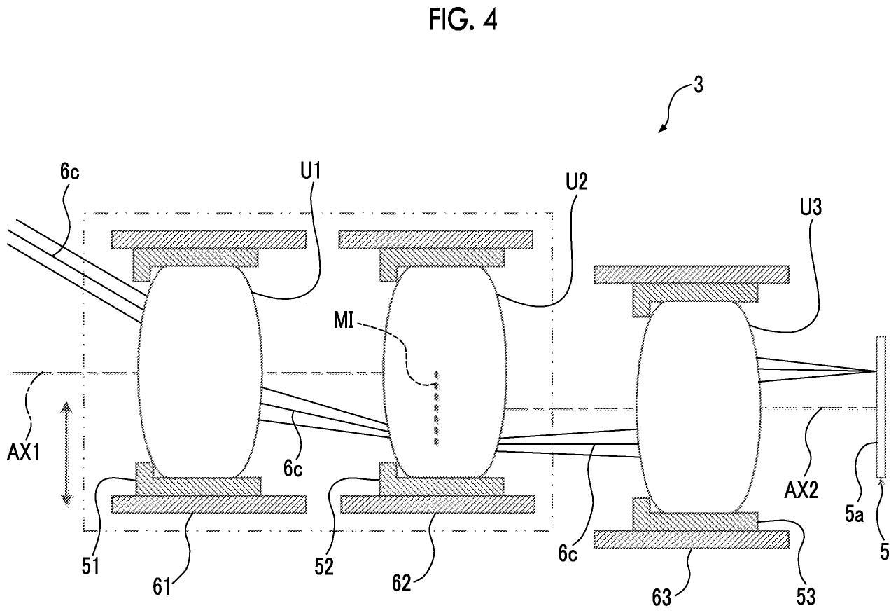

Next, the third embodiment will be described. FIG. 4 shows a conceptual diagram of a configuration of an optical device 3 according to the third embodiment of the present disclosure. The illustration method of FIG. 4 is basically the same as that of FIG. 1. The optical device 3 includes the first optical system U1 and the second optical system U2 in order from the magnification side to the reduction side along the optical path, and further includes the third optical system U3 on the optical path closer to the reduction side than the second optical system U2. In the third embodiment, the first optical system U1 and the second optical system U2 are coaxial systems having the common optical axis AX1, and the third optical system U3 is a coaxial system having the optical axis AX2. The optical axis AX1 corresponds to the “first optical axis” according to the technique of the present disclosure, and the optical axis AX2 corresponds to the “second optical axis” according to the technique of the present disclosure. The optical axis AX1 and the optical axis AX2 are parallel to each other and are not on the same straight line. In other words, the optical axis AX1 and the optical axis AX2 are in a parallel-shifted relationship. It should be noted that the term “parallel” in the present specification includes not only perfect parallelism but also substantially parallelism including an error generally allowed in the technical field to which the technique of the present disclosure belongs. The allowable error is, for example, within a range in which the angle formed by the optical axis AX1 and the optical axis AX2 is −1 degree or more and +1 degree or less.

In the third embodiment, the first optical system U1 and the second optical system U2 can be integrally shifted in a direction parallel to the image display surface 5a in a state where the optical axis AX1 and the optical axis AX2 are shifted in parallel and the third optical system U3 remains stationary. Therefore, the image circle of the third optical system U3 can be reduced. Thereby, it is possible to achieve reduction in size of the optical system. In the third embodiment, the intermediate image MI is formed closer to the reduction side than the first optical system U1. That is, by providing the relay optical system closer to the reduction side than the first optical system U1, it is easy to ensure the back focal length on the reduction side of the optical device 3. Thereby, the color synthesis prism and the like are easily disposed. It is preferable that the intermediate image MI is formed between the surface closest to the magnification side in the second optical system U2 and the surface closest to the reduction side in the second optical system U2. In such a case, since the second optical system U2 can have the same function as the field lens, there is an advantage in achieving reduction in size of the second optical system U2.

It is preferable that the second optical system U2 and the third optical system U3 are housed in different lens barrels, and the second optical system U2 is configured to be interchangeable. In FIG. 4, a lens barrel 62 houses the second optical system U2, and a lens barrel 63 houses the third optical system U3. The lens barrel 63 corresponds to the “third lens barrel” according to the technique of the present disclosure. In a case where the third optical system U3 includes a lens, a lens frame 53 is provided inside the lens barrel 63, and each lens or each lens group of the third optical system U3 is disposed in the lens frame 53. In a case where a plurality of lenses or lens groups of the third optical system U3 is present, a plurality of lens frames 53 are also present as many as the number of lenses or lens groups. The lens barrel 63 is a member that collectively houses the lens frames 53 and holds the entire third optical system U3. It is also possible to remove the lens frame 53 by configuring the lens barrel 63 to directly hold each lens or each lens group. The lens barrel 63 and the lens barrel 62 are separate members different from each other. Therefore, it is possible to replace only the second optical system U2 while the third optical system U3 remains stationary, and it is possible to provide a highly convenient apparatus.

Further, in the third embodiment, it is preferable that the third optical system U3 includes a group that moves by changing a spacing between adjacent groups during magnification change. That is, it is preferable that the third optical system U3 is a variable magnification optical system. In such a case, even in a case where the first optical system U1 is a fixed focus optical system, the size of the projected image can be easily changed, and a highly convenient apparatus can be provided. The third optical system U3 can be, for example, a zoom lens.

The above-mentioned preferred configurations and available configurations including the configurations relating to Conditional Expressions may be any combination, and it is preferable to appropriately and selectively adopt the configurations in accordance with required specification. It should be noted that the conditional expressions that the optical device of the present disclosure preferably satisfies are not limited to the conditional expressions described in the form of the expression, and the lower limit and the upper limit are selected from the preferable and more preferable conditional expressions. The conditional expressions may include all conditional expressions obtained through optional combinations.

Next, examples of the optical device of the present disclosure will be described with reference to the drawings. In the drawings of examples and modification examples to be described below, configurations of lenses constituting each optical system are mainly shown, and the lens frame and the lens barrel are not shown. The reference numerals of the optical system and the lens group attached to the cross-sectional views of the examples and the modification examples are used independently for examples in order to avoid complication of description and drawings due to an increase in number of digits of the reference numerals. Therefore, even in a case where common reference numerals are attached in the drawings of different examples, components do not necessarily have a common configuration.

Among the examples to be described below, Examples 1 and 2 correspond to the first embodiment, Example 3 corresponds to the second embodiment, and Example 4-1, Example 4-2, Example 4-3, Example 5, Example 6, and Example 7 correspond to the third embodiment. Any of the first optical systems U1 of the examples to be described below can be applied as an interchangeable lens for a digital camera.

### Example 1

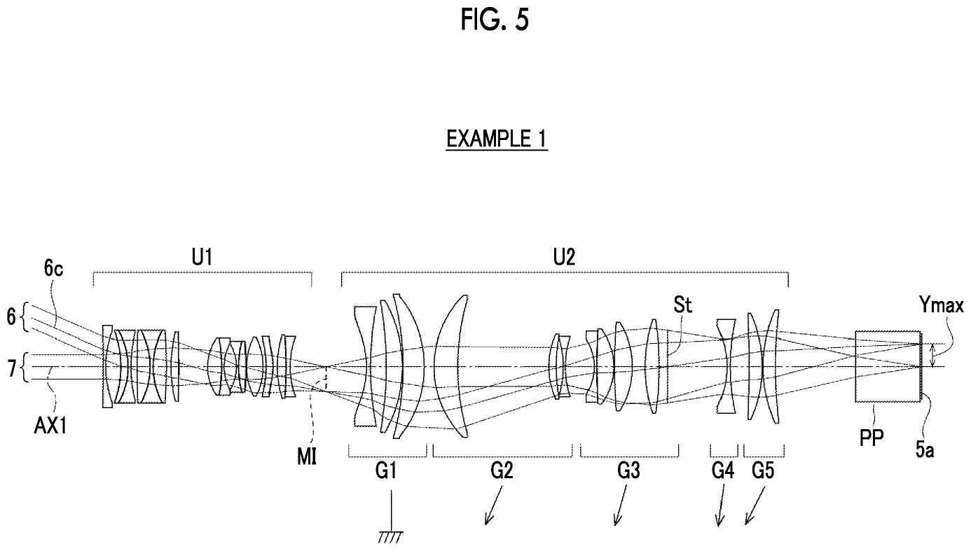

FIG. 5 shows a cross-sectional view of a configuration and luminous flux of an optical device of Example 1. FIG. 5 shows, as the luminous flux, on-axis luminous flux 7 and luminous flux 6 with the maximum angle of view. Further, in FIG. 5, the maximum image height Ymax used in the above conditional expression is shown as an example. The optical device of Example 1 includes the first optical system U1 and the second optical system U2 in order from the magnification side to the reduction side. The first optical system U1 and the second optical system U2 are coaxial systems having the common optical axis AX1. The intermediate image MI is formed between the first optical system U1 and the second optical system U2. The intermediate image MI in FIG. 5 indicates a position and does not necessarily indicate an accurate shape. The first optical system U1 and the second optical system U2 are housed in different lens barrels. The first optical system U1 and the second optical system U2 can be integrally shifted in the direction parallel to the image display surface 5a.

FIG. 5 shows an example in which the optical member PP is disposed between the second optical system U2 and the image display surface 5a on the assumption that the optical device is mounted on the projection type display apparatus. The optical member PP is a member which is regarded as a filter, a cover glass, a color synthesis prism, or the like. The optical member PP is a member that does not have power (refractive power), and a configuration in which the optical member PP is removed may be used.

The first optical system U1 consists of 15 lenses. The second optical system U2 consists of 13 lenses and an aperture stop St. The aperture stop St shown in FIG. 5 does not indicate the shape and size, but indicates the position in a direction of optical axis. The second optical system U2 is a variable magnification optical system. The second optical system U2 consists of, in order from the magnification side to the reduction side, five lens groups, that is, a first lens group G1, a second lens group G2, a third lens group G3, a fourth lens group G4, and a fifth lens group G5. During magnification change, the first lens group G1 remains stationary with respect to the image display surface 5a, and the other four lens groups move along the optical axis AX1 by changing the spacing between the adjacent groups. In FIG. 5, a ground symbol is shown below the lens group stationary during magnification change, and a direction of movement of each lens during magnification change from the wide angle end to the telephoto end is schematically indicated by an arrow below the lens group moving during the magnification change.

Regarding the optical device of Example 1, Tables 1A and 1B show basic lens data, Table 2 shows specifications and variable surface spacings, and Table 3 shows aspherical coefficients. Here, the basic lens data is shown to be divided into two tables, Table 1A and Table 1B, in order to avoid lengthening of one table.

The table of basic lens data will be described as follows. The “Sn” column shows surface numbers in a case where the surface closest to the magnification side is the first surface and the number is increased one by one toward the reduction side. The “R” column shows the curvature radius of each surface. The “D” column shows a surface spacing between each surface and the surface adjacent to the reduction side on the optical axis. The “Nd” column shows a refractive index of each component at the d line. The “vd” column shows an Abbe number of each component based on the d line. The rightmost column is separated for each optical system and shows a reference numeral of each corresponding optical system. For example, the column labeled U1 corresponds to the first optical system U1, and the column labeled U2 corresponds to the second optical system U2.

In the basic lens data, the sign of the curvature radius of the convex surface facing toward the magnification side is positive and the sign of the curvature radius of the convex surface facing toward the reduction side is negative. In a cell of a surface number of a surface corresponding to the aperture stop St, the surface number and a term of (St) are noted. The optical member PP is also shown in the basic lens data. A value at the bottom cell of D in Table 1B indicates a spacing between the image display surface 5a and the surface closest to the reduction side in the table. In the table of basic lens data, the symbol DD[ ] is used for each variable surface spacing, and the magnification side surface number of the spacing is given in [ ] and is noted in the D column.

Table 2 shows the magnification change ratio Zr, the absolute value of the focal length |f|, the F number FNo., the maximum total angle of view 2ω, and the variable surface spacing during magnification change, on the basis of the d line. [° ] in the cells of 2ω indicates that the unit thereof is a degree. In Table 2, The “wide” and “tele” columns show values in the wide angle end state and the telephoto end state, respectively.

In basic lens data, a reference sign * is attached to surface numbers of aspherical surfaces, and numerical values of the paraxial curvature radius are written into the column of the curvature radius of the aspherical surface. In Table 3, the Sn row shows surface numbers of the aspherical surfaces, and the KA and Am rows show numerical values of the aspherical coefficients for each aspherical surface. It should be noted that m of Am is an integer of 3 or more, and differs depending on the surface. For example, in the twentieth surface of Example 1, m=3, 4, 5, . . . , and 14. The “E±n” (n: an integer) in numerical values of the aspherical coefficients of Table 3 indicates “×10^{±n}”. KA and Am are the aspherical coefficients in the aspherical surface expression represented by the following expression.

Zd=C×h²/{1+(1−KA×C²×h²)^{1/2}}ΣAm×h^{m}

Here, Zd is an aspherical surface depth (a length of a perpendicular from a point on an aspherical surface at height h to a plane that is perpendicular to the optical axis and that is in contact with the vertex of the aspherical surface), h is a height (a distance from the optical axis to the lens surface), C is a reciprocal of a paraxial curvature radius, KA and Am are aspherical coefficients, and Σ in the aspherical surface expression means the sum with respect to m.

In the data of each table, degrees are used as a unit of an angle, and millimeters (mm) are used as a unit of a length, but appropriate different units may be used since the optical system can be used even in a case where the system is enlarged or reduced in proportion. Further, each of the following tables shows numerical values rounded off to predetermined decimal places.

TABLE 1A
Example 1

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 11.63 | | | |
| 12 | 20.3442 | 5.7 | 1.59282 | 68.62 | |
| 13 | −62.1811 | 1.01 | 1.53172 | 48.85 | |
| 14 | 19.7263 | 4.9315 | | | |
| 15 | −18.5053 | 0.9 | 1.71736 | 29.5 | |
| 16 | 41.418 | 2.78 | 1.6968 | 55.53 | |
| 17 | −131.9641 | 0.2 | | | |
| 18 | 26.3178 | 6.64 | 1.59282 | 68.62 | |
| 19 | −26.3178 | 1.21 | | | |
| *20 | −47.8136 | 2.75 | 1.80882 | 40.97 | |
| *21 | −29.9011 | 1.75 | | | |
| 22 | 41.9378 | 3.47 | 1.59282 | 68.62 | |
| 23 | −182.0569 | 0.1705 | | | |
| *24 | −96.5919 | 1.6 | 1.68948 | 31.02 | |
| *25 | 39.8918 | 30.6421 | | | |

TABLE 1B
Example 1

| Sn | R | D | Nd | νd | |
|---|---|---|---|---|---|
| *26 | −35.8154 | 1.6191 | 1.51633 | 64.14 | U2 |
| 27 | 123.2724 | 6.4042 | | | |
| 28 | −150.2106 | 6.4999 | 1.80518 | 25.46 | |
| 29 | −53.6143 | 0.3005 | | | |
| 30 | −105.4315 | 8.5002 | 2.001 | 29.13 | |
| *31 | −45.6348 | DD[31] | | | |
| 32 | 40.4727 | 9.5497 | 1.804 | 46.53 | |
| 33 | 95.5283 | 36.6878 | | | |
| 34 | 31.6615 | 2.9902 | 1.804 | 46.53 | |
| 35 | 64.5385 | 2.8589 | | | |
| 36 | −38.3431 | 0.8007 | 1.84666 | 23.78 | |
| 37 | 38.2396 | DD[37] | | | |
| 38 | −19.9218 | 1.001 | 1.84666 | 23.78 | |
| 39 | 248.8815 | 0.0594 | | | |
| 40 | 258.8251 | 6.8203 | 1.59522 | 67.73 | |
| 41 | −24.8823 | 0.3001 | | | |
| 42 | 243.8753 | 7.1139 | 1.53775 | 74.7 | |
| 43 | −33.8694 | 5.1522 | | | |
| 44 | 59.5977 | 5.6569 | 1.59522 | 67.73 | |
| 45 | −123.8267 | 3.3973 | | | |
| 46(St) | ∞ | DD[46] | | | |
| 47 | −35.9547 | 1.2913 | 1.5927 | 35.31 | |
| 48 | 85.8401 | DD[48] | | | |
| 49 | −497.1762 | 5.3117 | 1.84666 | 23.78 | |
| 50 | −50.925 | 0.3 | | | |
| 51 | 55.0552 | 4.9991 | 2.001 | 29.13 | |
| 52 | 183.6523 | DD[52] | | | |
| 53 | ∞ | 26 | 1.51633 | 64.14 | |
| 54 | ∞ | 0 | | | |

TABLE 2
Example 1

| | wide | tele |
|---|---|---|
| Zr | 1 | 1.10 |
| \|f\| | 21.87 | 24.06 |
| FNo. | 2.21 | 2.33 |
| 2ω[°] | 64.8 | 59.8 |
| DD[31] | 3.94 | 2 |
| DD[37] | 11.66 | 9.21 |
| DD[46] | 23.77 | 26.88 |
| DD[48] | 7.56 | 6.93 |
| DD[52] | 32.85 | 34.77 |

TABLE 3
Example 1

| Sn | 20 | 21 | 24 | 25 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

| Sn | 26 | 31 |
|---|---|---|
| KA | −0.61835852 | 0.77097498 |
| A4 | 1.07752E−07 | −3.84931E−07 |
| A6 | −6.42455E−09 | −5.14596E−10 |
| A8 | 6.7999E−11 | 3.72886E−13 |
| A10 | −6.37604E−14 | −3.94517E−16 |

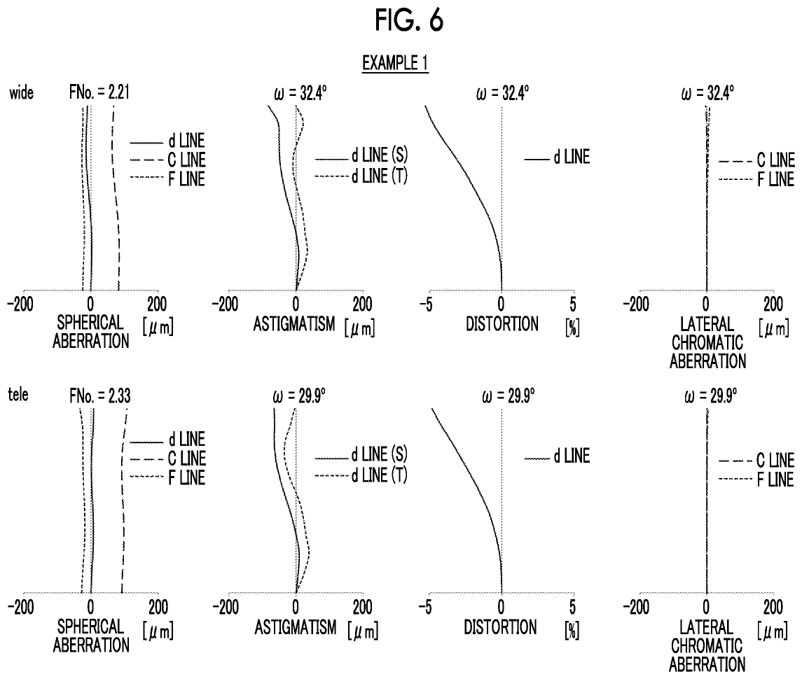

FIG. 6 shows aberration diagrams of the optical device of Example 1 in a state where the projection distance (the distance on the optical axis from the lens surface closest to the magnification side to the screen) is infinite. In FIG. 6, the top part labeled “wide” shows aberration diagrams at the wide angle end, and the lower part labeled “tele” shows aberration diagrams at the telephoto end. FIG. 6 shows, in order from the left, spherical aberration, astigmatism, distortion, and lateral chromatic aberration. In the spherical aberration diagram, aberrations at the d line, C line, and F line are indicated by the solid line, the long broken line, and the short broken line, respectively. In the astigmatism diagram, the aberration at the d line in the sagittal direction is indicated by a solid line, and the aberration at the d line in the tangential direction is indicated by the short broken line. In the distortion diagram, aberration at the d line is indicated by the solid line. In the lateral chromatic aberration diagram, aberrations at the C line and the F line are indicated by the long broken line and the short broken line, respectively. In the spherical aberration diagram, the value of the F number is shown after “FNo.=”. In other aberration diagrams, the value of the maximum half angle of view is shown after “ω=”.

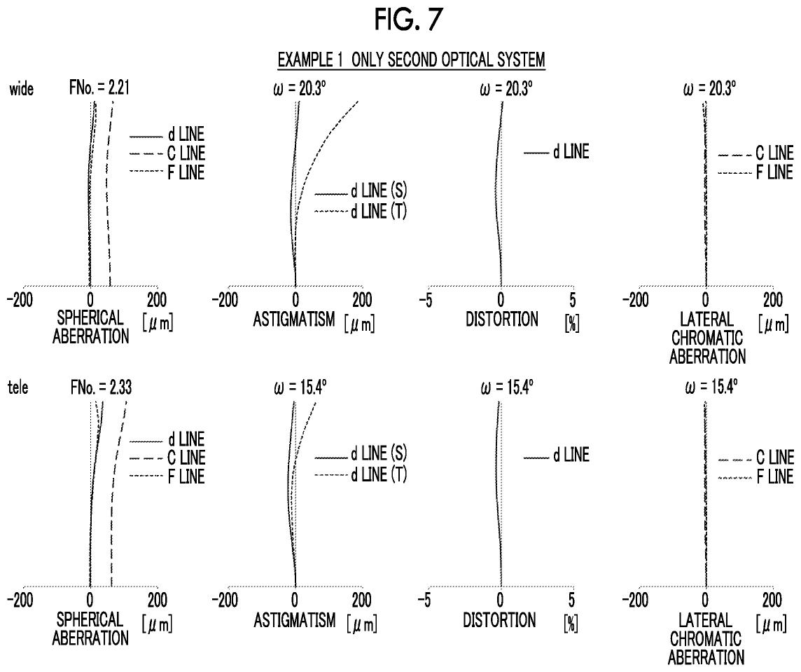

FIG. 7 shows aberration diagrams of only the second optical system U2. The illustration method of FIG. 7 is the same as that of FIG. 6. In each aberration diagram of only the second optical system U2, the position of the image formed by the first optical system U1 in a state where the projection distance is infinite is obtained as an object position for the second optical system U2, through ray tracing of the second optical system U2. In the present specification, for convenience, the distance on the optical axis from the position of the object to the surface closest to the magnification side in the second optical system U2 will be referred to as “an object distance of the second optical system U2”. The sign of the object distance of the second optical system U2 is positive in a case where the surface closest to the magnification side in the second optical system U2 is closer to the reduction side than the object position, and is negative in a case where the surface closest to the magnification side in the second optical system U2 is closer to the magnification side than the object position. In Example 1, the object distance of the second optical system U2 is 16.13 millimeters (mm).

Symbols, meanings, description methods, and illustration methods of the respective data pieces according to Example 1 are basically similar to those in the following examples unless otherwise specified. Therefore, in the following description, repeated description will not be given. In the following drawings of examples and modification examples, the description of reference numerals of the on-axis luminous flux 7, the luminous flux 6 with the maximum angle of view, and the maximum image height Ymax will not be repeated.

### Example 2

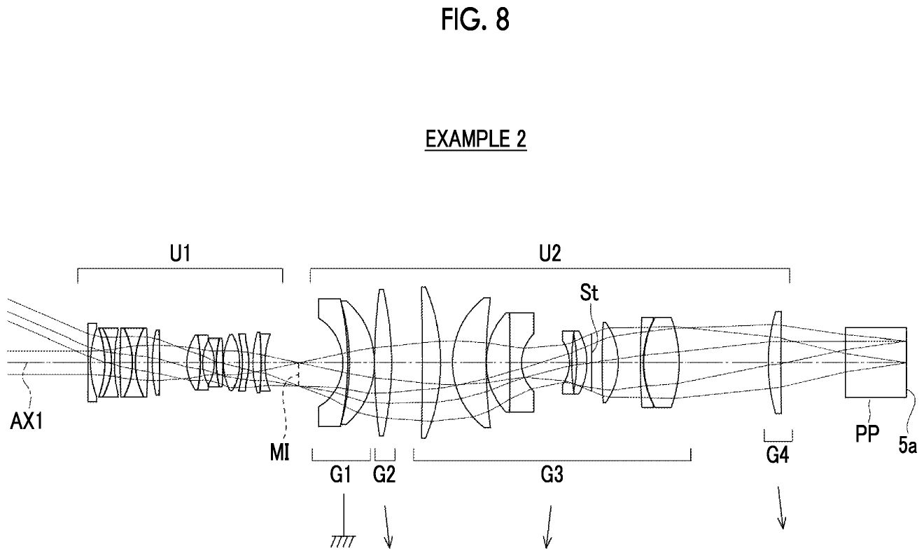

FIG. 8 shows a cross-sectional view of a configuration and luminous flux of an optical device of Example 2. The optical device of Example 2 includes the first optical system U1 and the second optical system U2 in order from the magnification side to the reduction side. The first optical system U1 and the second optical system U2 are coaxial systems having the common optical axis AX1. The intermediate image MI is formed between the first optical system U1 and the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 15 lenses. The second optical system U2 consists of 13 lenses and the aperture stop St. The second optical system U2 is a variable magnification optical system. The second optical system U2 consists of, in order from the magnification side to the reduction side, four lens groups, that is, a first lens group G1, a second lens group G2, a third lens group G3, and a fourth lens group G4. During magnification change, the first lens group G1 remains stationary with respect to the image display surface 5a, and the other three lens groups move along the optical axis AX1 by changing the spacing between the adjacent groups.

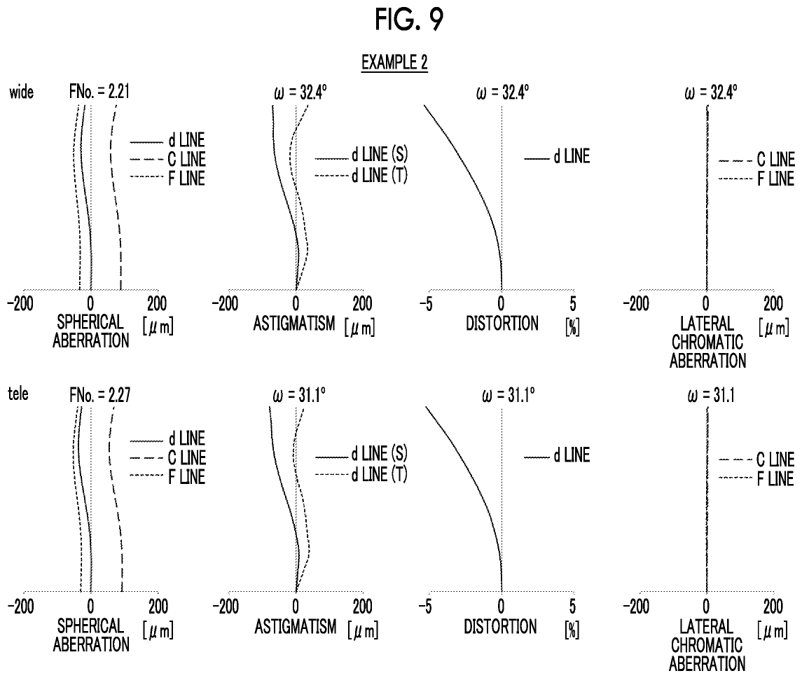

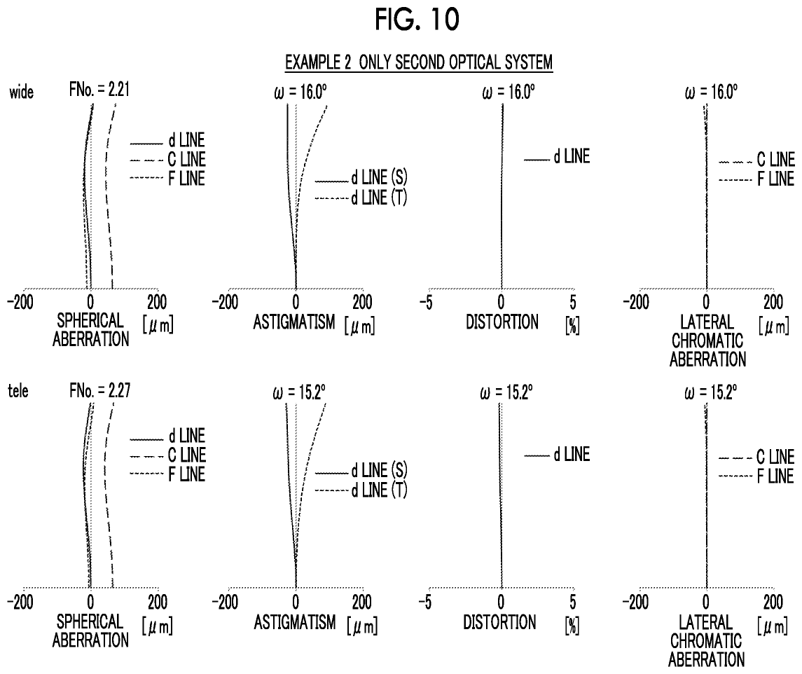

Regarding the optical device of Example 2, Tables 4A and 4B shows basic lens data, Table 5 shows specifications and variable surface spacing, Table 6 shows aspherical coefficients, and FIG. 9 shows aberration diagrams in a state where the projection distance is infinite. FIG. 10 shows the aberration diagrams of only the second optical system U2. The object distance of the second optical system U2 is 18.57 millimeters (mm).

TABLE 4A
Example 2

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 11.63 | | | |
| 12 | 20.3442 | 5.7 | 1.59282 | 68.62 | |
| 13 | −62.1811 | 1.01 | 1.53172 | 48.85 | |
| 14 | 19.7263 | 4.9315 | | | |
| 15 | −18.5053 | 0.9 | 1.71736 | 29.51 | |
| 16 | 41.418 | 2.78 | 1.6968 | 55.53 | |
| 17 | −131.9641 | 0.2 | | | |
| 18 | 26.3178 | 6.64 | 1.59282 | 68.62 | |
| 19 | −26.3178 | 1.21 | | | |
| *20 | −47.8136 | 2.75 | 1.8078 | 40.86 | |
| *21 | −29.9011 | 1.75 | | | |
| 22 | 41.9378 | 3.47 | 1.59282 | 68.62 | |
| 23 | −182.0569 | 0.1705 | | | |
| *24 | −96.5919 | 1.6 | 1.68863 | 31.2 | |
| *25 | 39.8918 | 33.095 | | | |

TABLE 4B
Example 2

| Sn | R | D | Nd | νd | |
|---|---|---|---|---|---|
| 26 | −22.2344 | 2 | 1.51742 | 52.43 | U2 |
| 27 | −120.2883 | 0.7878 | | | |
| 28 | −94.1966 | 10.6176 | 1.92286 | 20.88 | |
| 29 | −34.4009 | DD[29] | | | |
| 30 | 231.9183 | 7.2253 | 1.5927 | 35.31 | |
| 31 | −139.668 | DD[31] | | | |
| 32 | −1840.4421 | 7.8756 | 1.56883 | 56.04 | |
| 33 | −81.7427 | 5.0456 | | | |
| 34 | 34.7603 | 14.3168 | 1.58913 | 61.13 | |
| 35 | 208.8103 | 0.05 | | | |
| 36 | 30.2066 | 10.0009 | 1.497 | 81.61 | |
| 37 | −2862.8707 | 0.0505 | | | |
| 38 | −1631.7423 | 4.9595 | 1.80518 | 25.46 | |
| 39 | 16.6927 | 20.3513 | | | |
| 40 | −16.1964 | 1 | 1.72825 | 28.46 | |
| 41 | 88.6931 | 2.0739 | | | |
| 42 | −58.7465 | 4.3871 | 1.72916 | 54.68 | |
| 43 | −26.9001 | 1.9231 | | | |
| 44(St) | ∞ | 4.5 | | | |
| 45 | 327.9031 | 6.9629 | 1.59282 | 68.62 | |
| 46 | −28.7163 | 9.4051 | | | |
| 47 | 279.5711 | 1.2 | 1.62004 | 36.26 | |
| 48 | 39.1756 | 0.2773 | | | |
| 49 | 40.4307 | 15.0009 | 1.497 | 81.61 | |
| 50 | −54.4655 | DD[50] | | | |
| 51 | 74.733 | 5.3359 | 1.92286 | 20.88 | |
| 52 | 825.5497 | DD[52] | | | |
| 53 | ∞ | 26 | 1.5168 | 64.2 | |
| 54 | ∞ | 0 | | | |

TABLE 5
Example 2

| | wide | tele |
|---|---|---|
| Zr | 1 | 1.05 |
| \|f\| | 21.87 | 22.97 |
| FNo. | 2.21 | 2.27 |
| 2ω[°] | 64.8 | 62.2 |
| DD[29] | 0.05 | 1.7 |
| DD[31] | 13.07 | 6.65 |
| DD[50] | 37.67 | 42.75 |
| DD[52] | 27.47 | 27.14 |

TABLE 6
Example 2

| Sn | 20 | 21 | 24 | 25 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

### Example 3

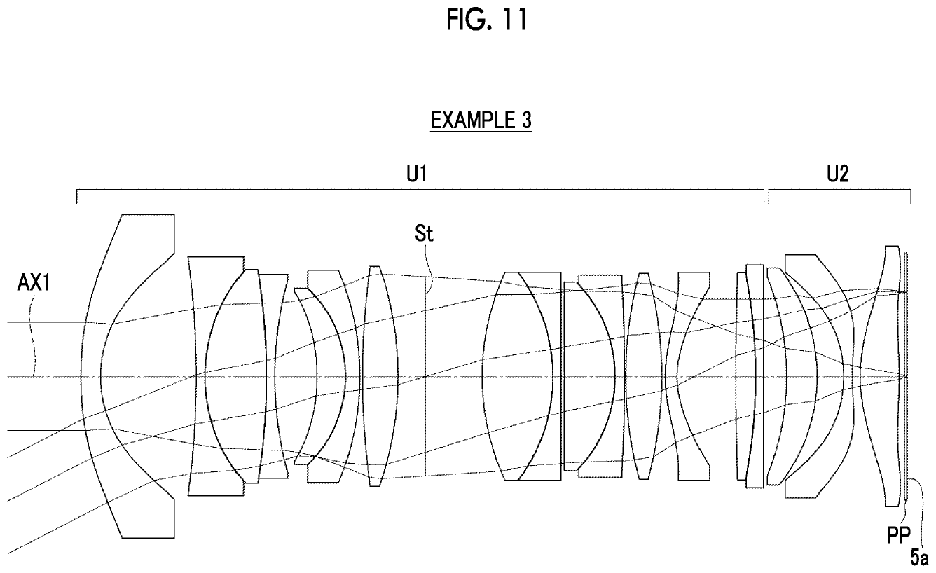

FIG. 11 shows a cross-sectional view of a configuration and luminous flux of an optical device of Example 3. The optical device of Example 3 includes the first optical system U1 and the second optical system U2 in order from the magnification side to the reduction side. The first optical system U1 is the imaging lens of Example 1 described in JP2022-16016A. The first optical system U1 and the second optical system U2 are coaxial systems having the common optical axis AX1. The optical device of Example 3 does not form the intermediate image MI. The first optical system U1 and the second optical system U2 are housed in different lens barrels. The first optical system U1 and the second optical system U2 can be integrally shifted in the direction parallel to the image display surface 5a. The first optical system U1 consists of 15 lenses and the aperture stop St. The second optical system U2 consists of three lenses.

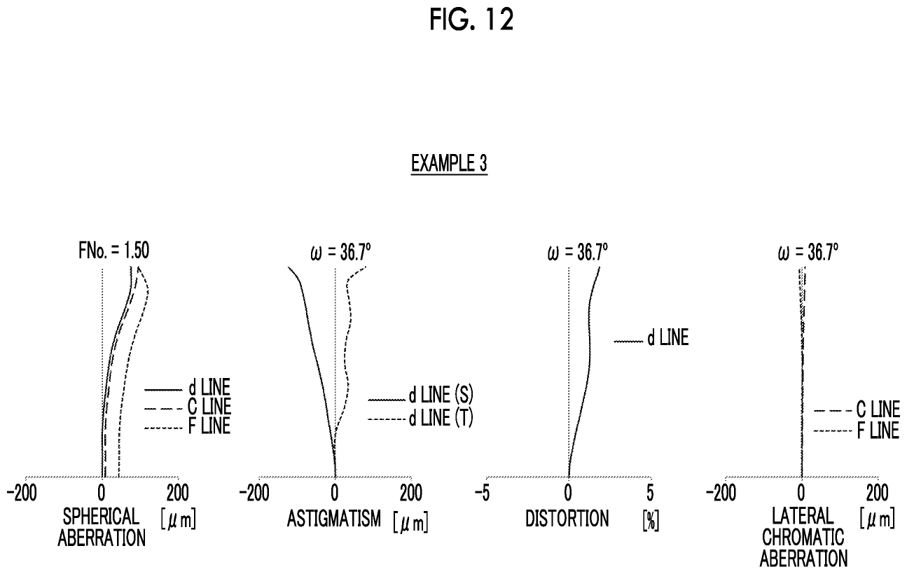

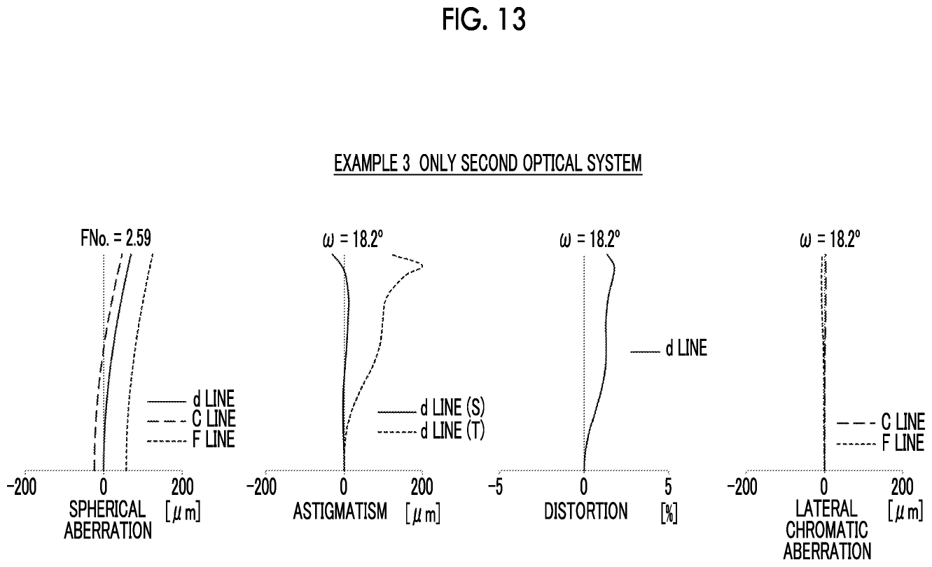

Regarding the optical device of Example 3, Table 7 shows basic lens data, Table 8 shows specifications, Table 9 shows aspherical coefficients, and FIG. 12 shows aberration diagrams in a state where the projection distance is infinite. FIG. 13 shows aberration diagrams of only the second optical system U2. The object distance of the second optical system U2 is −58.3 millimeters (mm).

TABLE 7
Example 3

| Sn | R | D | Nd | νd | |
|---|---|---|---|---|---|
| *1 | 42.5066 | 2.26 | 1.58313 | 59.46 | U1 |
| *2 | 14.3565 | 11.0287 | | | |
| 3 | −100.1648 | 1.02 | 1.58313 | 59.46 | |
| 4 | 18.6299 | 7.05 | 1.8919 | 37.13 | |
| 5 | −75.498 | 0.97 | 1.48749 | 70.42 | |
| 6 | 42.5062 | 4.8671 | | | |
| *7 | −20.6839 | 3.28 | 1.58254 | 59.44 | |
| 8 | −13.9817 | 1.66 | 2.00069 | 25.43 | |
| 9 | −31.4975 | 0.3 | | | |
| 10 | 89.0372 | 4.11 | 1.95375 | 32.32 | |
| 11 | −38.477 | 3.139 | | | |
| 12(St) | ∞ | 6.5784 | | | |
| 13 | 28.6629 | 8.18 | 1.59282 | 68.62 | |
| 14 | −19.7999 | 0.91 | 1.85451 | 25.15 | |
| 15 | ∞ | 0.4007 | | | |
| 16 | ∞ | 5.85 | 1.7725 | 49.61 | |
| 17 | −15.454 | 1.09 | 1.85451 | 25.15 | |
| 18 | −209.9846 | 0.1389 | | | |
| 19 | 45.3596 | 4.16 | 2.00272 | 19.32 | |
| 20 | −45.3596 | 0.4 | | | |
| *21 | 16.1711 | 1.3856 | 1.8061 | 40.73 | |
| *22 | 11.0173 | 6.7182 | | | |
| 23 | 363.2443 | 2.28 | 1.603 | 65.46 | |
| 24 | −62.1067 | 0.92 | 1.84666 | 23.78 | |
| 25 | ∞ | 2.6556 | | | |
| 26 | −30.4666 | 3.5267 | 1.91082 | 35.25 | U2 |
| 27 | −20.0667 | 3.0753 | | | |
| *28 | −14.4183 | 1 | 1.74077 | 27.76 | |
| *29 | 29.8146 | 0.9007 | | | |
| *30 | 17.2075 | 4.4994 | 2.001 | 29.13 | |
| *31 | −58.2514 | 0.5991 | | | |
| 32 | ∞ | 0.3 | 1.5168 | 64.2 | |
| 33 | ∞ | 0 | | | |

TABLE 8
Example 3

| | |
|---|---|
| \|f\| | 18.73 |
| FNo. | 1.5 |
| 2ω[°] | 73.4 |

TABLE 9
Example 3

| Sn | 1 | 2 | 7 | 21 | 22 |
|---|---|---|---|---|---|
| KA | 3.8510739 | −4.3296751 | −3.0025953 | −5.0000027 | 1.4211109 |
| A3 | 0 | 0 | 0 | 0 | 0 |
| A4 | 8.21013E−05 | 0.000310699 | −5.99947E−05 | −1.56899E−05 | 3.0066E−05 |
| A5 | −9.574E−06 | −1.0193E−05 | 6.16895E−07 | −6.58027E−06 | −1.94313E−05 |
| A6 | 5.95886E−07 | −9.90291E−07 | −1.27982E−06 | −6.92551E−07 | 3.3139E−06 |
| A7 | −3.0456E−08 | 7.41659E−09 | 3.93277E−07 | 1.44799E−08 | −4.37164E−07 |
| A8 | −1.94805E−09 | 5.81716E−09 | −3.45978E−08 | 1.41227E−08 | 2.81052E−08 |
| A9 | 4.08645E−10 | 1.70377E−10 | −2.39255E−09 | −3.49649E−10 | 1.7441E−09 |
| A10 | −1.49197E−11 | −1.63212E−11 | 3.71505E−10 | −7.55908E−11 | −1.54175E−10 |
| A11 | −1.82577E−13 | −1.49036E−12 | 3.90669E−11 | 6.11732E−12 | −2.30688E−11 |
| A12 | −2.71477E−14 | −2.87462E−13 | −6.39448E−12 | −9.66037E−13 | 1.28151E−12 |
| A13 | 3.46186E−15 | 5.17533E−14 | −1.99555E−13 | 7.72513E−14 | 2.3111E−13 |
| A14 | −2.72278E−18 | −2.52859E−15 | 7.42065E−14 | 1.11076E−15 | −2.73713E−14 |
| A15 | −6.67053E−18 | 4.08089E−17 | −4.36547E−15 | −3.0215E−16 | 1.20108E−15 |
| A16 | 1.49943E−19 | −8.79931E−21 | 7.94244E−17 | 7.84654E−18 | −2.14997E−17 |

| Sn | 28 | 29 | 30 | 31 |
|---|---|---|---|---|
| KA | 1 | 1 | 1 | 1 |
| A4 | −0.000132817 | −0.000471283 | −0.000181709 | 0.00011754 |
| A6 | 1.26964E−06 | 2.32274E−06 | 1.09847E−06 | −1.87326E−07 |
| A8 | −7.23792E−09 | −7.23493E−09 | −5.38254E−09 | −1.90546E−09 |
| A10 | 2.80797E−11 | 1.22619E−11 | 8.12489E−12 | 5.09118E−12 |

### Example 4-1

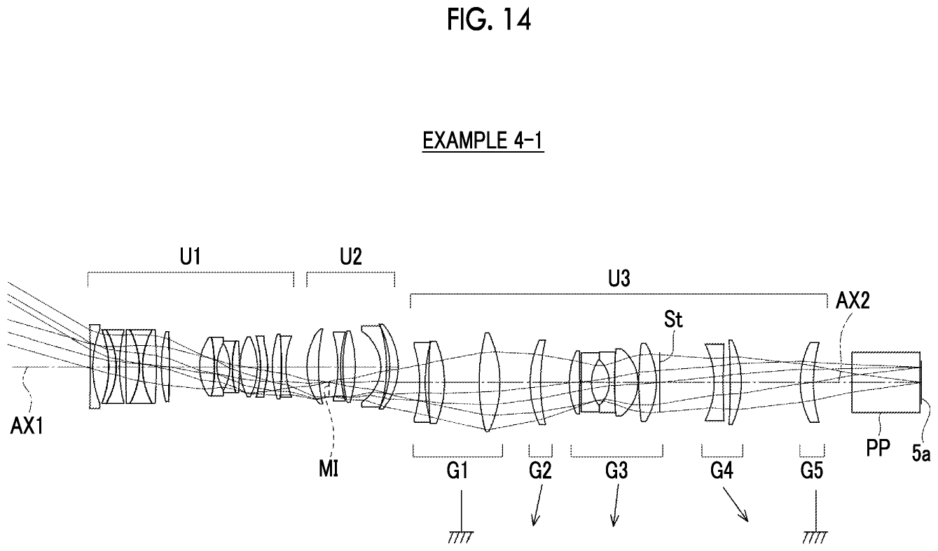

FIG. 14 shows a cross-sectional view of a configuration and luminous flux of an optical device of Example 4-1. The optical device of Example 4-1 includes the first optical system U1, the second optical system U2, and the third optical system U3, in order from the magnification side to the reduction side. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 15 lenses. The second optical system U2 consists of five lenses. The third optical system U3 consists of 12 lenses and the aperture stop St. The third optical system U3 is a variable magnification optical system. The third optical system U3 consists of, in order from the magnification side to the reduction side, five lens groups, that is, a first lens group G1, a second lens group G2, a third lens group G3, a fourth lens group G4, and a fifth lens group G5. During magnification change, the first lens group G1 and the fifth lens group G5 remain stationary with respect to the image display surface 5a, and the other three lens groups move along the optical axis AX2 by changing the spacing between the adjacent groups.

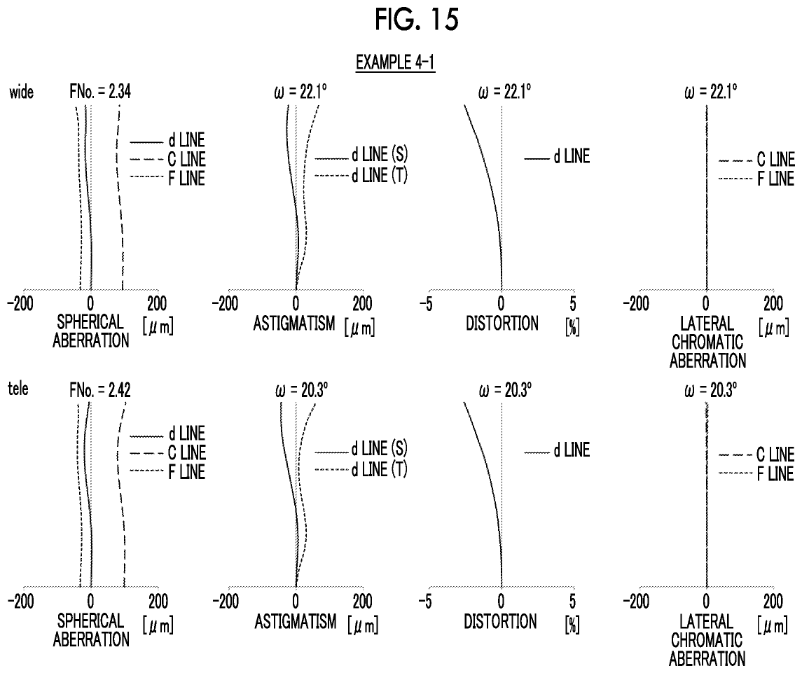

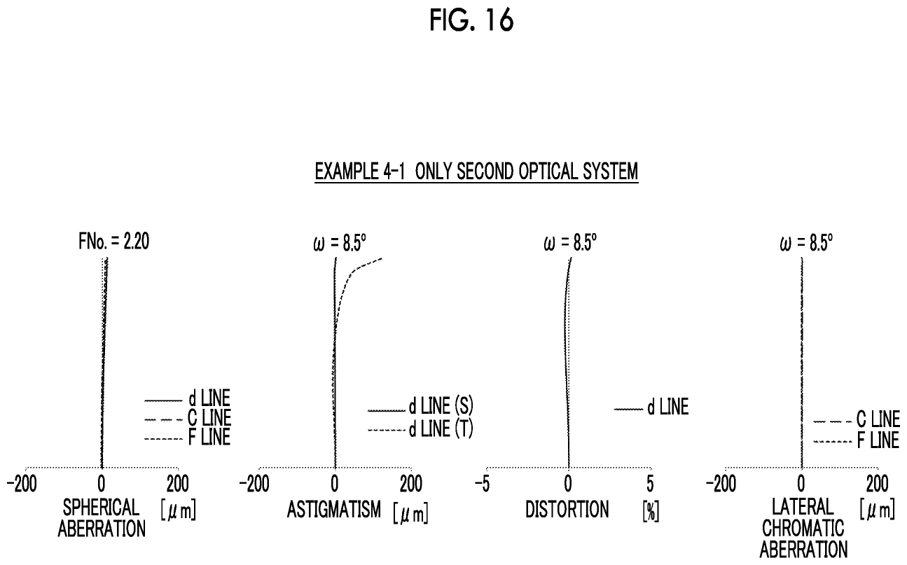

Regarding the optical device of Example 4-1, Tables 10A and 10B show basic lens data, Table 11 shows specifications and variable surface spacing, Table 12 shows aspherical coefficients, and FIG. 15 shows aberration diagrams in a state where the projection distance is infinite. FIG. 16 shows aberration diagrams of only the second optical system U2. The object distance of the second optical system U2 is −6.49 millimeters (mm). It should be noted that, for convenience, the lens data and the aberration diagrams show the optical axis AX1 and the optical axis AX2 on the same straight line. This point is similarly applied to Example 4-2, Example 4-3, Example 5, Example 6, and Example 7 to be described later.

TABLE 10A
Example 4-1

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 11.63 | | | |
| 12 | 20.3442 | 5.7 | 1.59282 | 68.62 | |
| 13 | −62.1811 | 1.01 | 1.53172 | 48.85 | |
| 14 | 19.7263 | 4.9315 | | | |
| 15 | −18.5053 | 0.9 | 1.71736 | 29.51 | |
| 16 | 41.418 | 2.78 | 1.6968 | 55.53 | |
| 17 | −131.9641 | 0.2 | | | |
| 18 | 26.3178 | 6.64 | 1.59282 | 68.62 | |
| 19 | −26.3178 | 1.21 | | | |
| *20 | −47.8136 | 2.75 | 1.80882 | 40.97 | |
| *21 | −29.9011 | 1.75 | | | |
| 22 | 41.9378 | 3.47 | 1.59282 | 68.62 | |
| 23 | −182.0569 | 0.1705 | | | |
| *24 | −96.5919 | 1.6 | 1.68948 | 31.02 | |
| *25 | 39.8918 | 8.0853 | | | |
| *26 | 28.0493 | 4.379 | 1.854 | 40.38 | U2 |
| 27 | 66.556 | 7.4833 | | | |
| 28 | −48.489 | 1 | 1.85451 | 25.15 | |
| 29 | 52.694 | 0.9053 | | | |
| 30 | 62.0634 | 4.7244 | 1.95375 | 32.32 | |
| 31 | −50.838 | 9.8098 | | | |
| 32 | −16.9772 | 2.2093 | 1.48749 | 70.24 | |
| 33 | −54.4931 | 1.2035 | | | |
| 34 | −36.285 | 3.2449 | 1.79952 | 42.24 | |
| 35 | −26.8901 | 8.2531 | | | |

TABLE 10B
Example 4-1

| Sn | R | D | Nd | νd | |
|---|---|---|---|---|---|
| 36 | −48.6352 | 2.1212 | 1.76182 | 26.52 | U3 |
| 37 | 62.9654 | 1.3584 | | | |
| 38 | 267.1389 | 6.0004 | 1.92286 | 20.88 | |
| 39 | −43.7191 | 13.1063 | | | |
| 40 | 78.1151 | 8.0004 | 1.59522 | 67.73 | |
| 41 | −46.4684 | DD[41] | | | |
| 42 | 41.4532 | 3.9992 | 1.80518 | 25.46 | |
| 43 | 76.4252 | DD[43] | | | |
| 44 | 30.2235 | 3.9996 | 1.72916 | 54.68 | |
| 45 | −1533.7002 | 0.4444 | | | |
| 46 | 6530.8583 | 4.0009 | 1.84666 | 23.78 | |
| 47 | 15.7842 | 6.8732 | | | |
| 48 | −12.4913 | 2.0009 | 1.84666 | 23.78 | |
| 49 | 202.2293 | 0.0309 | | | |
| 50 | 189.7227 | 9.0476 | 1.497 | 81.54 | |
| 51 | −16.9226 | 0.3002 | | | |
| 52 | 127.4894 | 6.711 | 1.59522 | 67.73 | |
| 53 | −31.5684 | 1.34 | | | |
| 54(St) | ∞ | DD[54] | | | |
| 55 | −35.0761 | 3.4292 | 1.48749 | 70.24 | |
| 56 | 307.6737 | 2.7715 | | | |
| 57 | −280.2248 | 4.219 | 1.883 | 40.8 | |
| 58 | −41.4744 | DD[58] | | | |
| 59 | 35.364 | 4.9998 | 1.92286 | 20.88 | |
| 60 | 57.9114 | 14.9306 | | | |
| 61 | ∞ | 26 | 1.51633 | 64.14 | |
| 62 | ∞ | 0.48 | | | |

TABLE 11
Example 4-1

| | wide | tele |
|---|---|---|
| Zr | 1 | 1.10 |
| \|f\| | 21.61 | 23.76 |
| FNo. | 2.34 | 2.42 |
| 2ω[°] | 44.2 | 40.6 |
| DD[41] | 11.55 | 4 |
| DD[43] | 11.04 | 14.84 |
| DD[54] | 20.83 | 43.2 |
| DD[58] | 22.61 | 4 |

TABLE 12
Example 4-1

| Sn | 20 | 21 | 24 | 25 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

| Sn | 26 |
|---|---|
| KA | 1.7733784 |
| A4 | 5.63595E−06 |
| A6 | 8.11156E−09 |
| A8 | −7.17724E−11 |
| A10 | 9.13509E−13 |
| A12 | −2.90729E−15 |
| A14 | −3.00509E−19 |
| A16 | 2.52662E−20 |

### Example 4-2

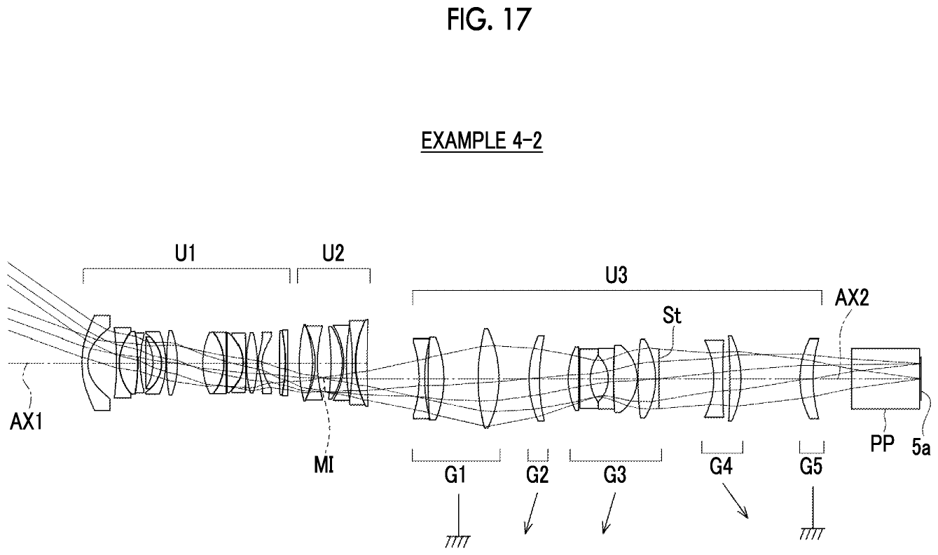

FIG. 17 shows a cross-sectional view of a configuration and luminous flux of an optical device of Example 4-2. The optical device of Example 4-2 includes the first optical system U1, the second optical system U2, and the third optical system U3, in order from the magnification side to the reduction side. The first optical system U1 is the imaging lens of Example 1 described in JP2022-16016A. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 15 lenses. The second optical system U2 consists of six lenses. The third optical system U3 of the optical device of Example 4-2 is common with the third optical system U3 of the optical device of Example 4-1.

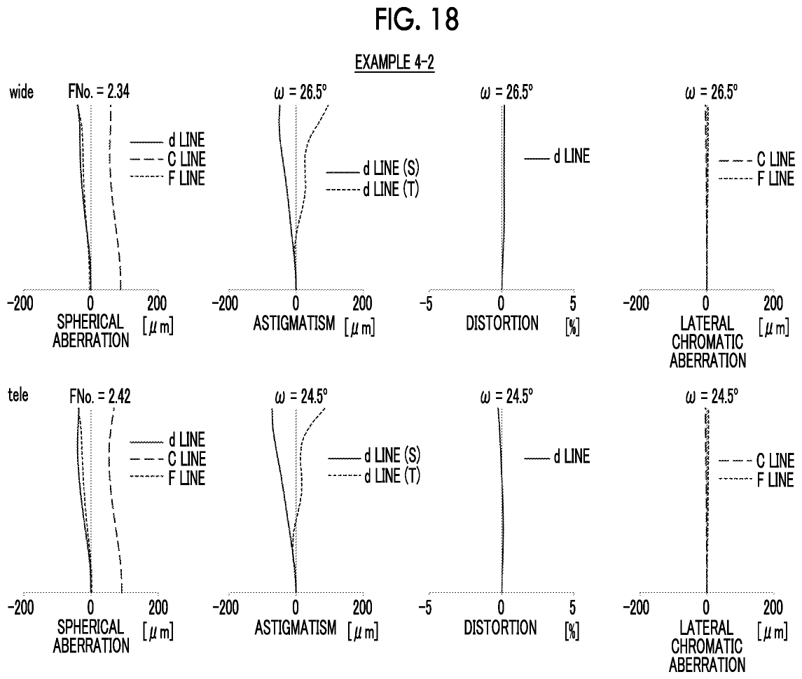

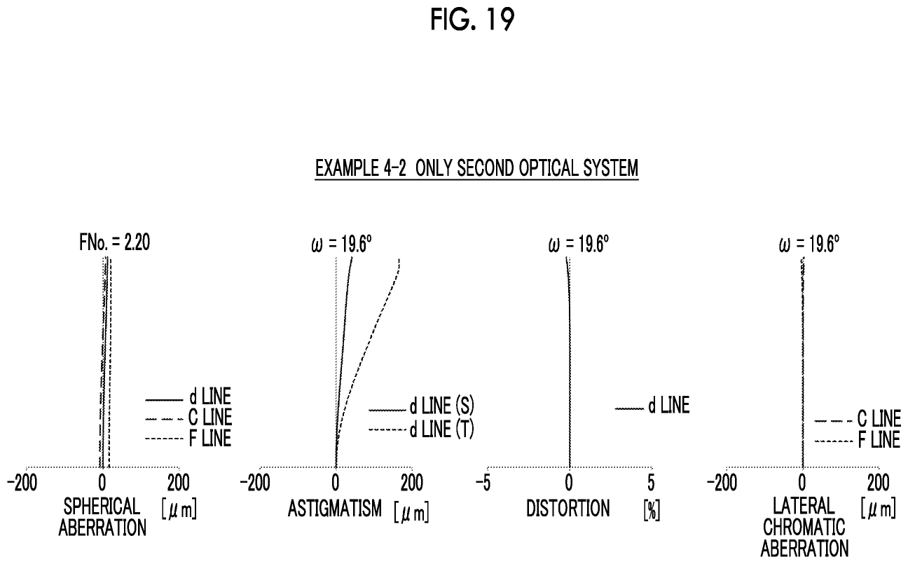

Regarding the optical device of Example 4-2, Tables 13A and 13B show basic lens data, Table 14 shows specifications and variable surface spacing, Table 15 shows aspherical coefficients, and FIG. 18 shows aberration diagrams in a state where the projection distance is infinite. FIG. 19 shows aberration diagrams of only the second optical system U2. The object distance of the second optical system U2 is −7.00 millimeters (mm).

TABLE 13A
Example 4-2

| Sn | R | D | Nd | νd | |
|---|---|---|---|---|---|
| *1 | 42.5066 | 2.26 | 1.58313 | 59.46 | U1 |
| *2 | 14.3565 | 11.0287 | | | |
| 3 | −100.1648 | 1.02 | 1.58313 | 59.46 | |
| 4 | 18.6299 | 7.05 | 1.8919 | 37.13 | |
| 5 | −75.498 | 0.97 | 1.48749 | 70.44 | |
| 6 | 42.5062 | 4.8671 | | | |
| *7 | −20.6839 | 3.28 | 1.58313 | 59.38 | |
| 8 | −13.9817 | 1.66 | 2.00069 | 25.43 | |
| 9 | −31.4975 | 0.3 | | | |
| 10 | 89.0372 | 4.11 | 1.95375 | 32.32 | |
| 11 | −38.477 | 9.7174 | | | |
| 12 | 28.6629 | 8.18 | 1.59282 | 68.62 | |
| 13 | −19.7999 | 0.91 | 1.85451 | 25.15 | |
| 14 | ∞ | 0.4007 | | | |
| 15 | ∞ | 5.85 | 1.7725 | 49.6 | |
| 16 | −15.454 | 1.09 | 1.85451 | 25.15 | |
| 17 | −209.9846 | 0.1389 | | | |
| 18 | 45.3596 | 4.16 | 2.00272 | 19.32 | |
| 19 | −45.3596 | 0.4 | | | |
| *20 | 16.1711 | 1.3856 | 1.8061 | 40.73 | |
| *21 | 11.0173 | 6.7182 | | | |
| 22 | 363.2443 | 2.28 | 1.603 | 65.46 | |
| 23 | −62.1067 | 0.92 | 1.84666 | 23.78 | |
| 24 | ∞ | 4.3762 | | | |
| 25 | 63.562 | 5.1 | 2.001 | 29.13 | U2 |
| 26 | −42.0954 | 0.9767 | | | |
| 27 | −30.073 | 0.9 | 1.437 | 95.1 | |
| 28 | 53.891 | 5.184 | | | |
| 29 | −111.5378 | 4.3346 | 1.8707 | 40.73 | |
| 30 | −26.584 | 0.5984 | | | |
| 31 | −28.5081 | 0.95 | 1.58144 | 40.75 | |
| 32 | 84.3015 | 2.3042 | | | |
| 33 | −99.8589 | 1.1 | 1.437 | 95.1 | |
| 34 | 37.8185 | 0.2153 | | | |
| 35 | 40.1769 | 4.4101 | 2.001 | 29.13 | |
| 36 | 537.1248 | 19.9135 | | | |

TABLE 13B
Example 4-2

| Sn | R | D | Nd | νd | |
|---|---|---|---|---|---|
| 37 | 48.6352 | 2.1212 | 1.76182 | 26.52 | U3 |
| 38 | 62.9654 | 1.3584 | | | |
| 39 | 267.1389 | 6.0004 | 1.92286 | 20.88 | |
| 40 | −43.7191 | 13.1063 | | | |
| 41 | 78.1151 | 8.0004 | 1.59522 | 67.73 | |
| 42 | −46.4684 | DD[42] | | | |
| 43 | 41.4532 | 3.9992 | 1.80518 | 25.46 | |
| 44 | 76.4252 | DD[44] | | | |
| 45 | 30.2235 | 3.9996 | 1.72916 | 54.68 | |
| 46 | −1533.7002 | 0.4444 | | | |
| 47 | 6530.8583 | 4.0009 | 1.84666 | 23.78 | |
| 48 | 15.7842 | 6.8732 | | | |
| 49 | −12.4913 | 2.0009 | 1.84666 | 23.78 | |
| 50 | 202.2293 | 0.0309 | | | |
| 51 | 189.7227 | 9.0476 | 1.497 | 81.54 | |
| 52 | −16.9226 | 0.3002 | | | |
| 53 | 127.4894 | 6.711 | 1.59522 | 67.73 | |
| 54 | −31.5684 | 1.34 | | | |
| 55(St) | ∞ | DD[55] | | | |
| 56 | −35.0761 | 3.4292 | 1.48749 | 70.24 | |
| 57 | 307.6737 | 2.7715 | | | |
| 58 | −280.2248 | 4.219 | 1.883 | 40.8 | |
| 59 | −41.4744 | DD[59] | | | |
| 60 | 35.364 | 4.9998 | 1.92286 | 20.88 | |
| 61 | 57.9114 | 14.9306 | | | |
| 62 | ∞ | 26 | 1.51633 | 64.14 | |
| 63 | ∞ | 0.48 | | | |

TABLE 14
Example 4-2

| | wide | tele |
|---|---|---|
| Zr | 1 | 1.10 |
| \|f\| | 17.11 | 18.82 |
| FNo. | 2.34 | 2.42 |
| 2ω[°] | 53 | 49 |
| DD[42] | 11.55 | 4 |
| DD[44] | 11.04 | 14.84 |
| DD[55] | 20.83 | 43.2 |
| DD[59] | 22.61 | 4 |

TABLE 15
Example 4-2

| Sn | 1 | 2 | 7 | 20 | 21 |
|---|---|---|---|---|---|
| KA | 3.8510739 | −4.3296751 | −3.0025953 | −5.0000027 | −1.4211109 |
| A3 | 0 | 0 | 0 | 0 | 0 |
| A4 | 8.21013E−05 | 0.000310699 | −5.99947E−05 | −1.56899E−05 | 3.0066E−05 |
| A5 | −9.574E−06 | −1.0193E−05 | 6.16895E−07 | −6.58027E−06 | −1.94313E−05 |
| A6 | 5.95886E−07 | −9.90291E−07 | −1.27982E−06 | −6.92551E−07 | 3.3139E−06 |
| A7 | −3.0456E−08 | 7.41659E−09 | 3.93277E−07 | 1.44799E−08 | −4.37164E−07 |
| A8 | −1.94805E−09 | 5.81716E−09 | −3.45978E−08 | 1.41227E−08 | 2.81052E−08 |
| A9 | 4.08645E−10 | 1.70377E−10 | −2.39255E−09 | −3.49649E−10 | 1.7441E−09 |
| A10 | −1.49197E−11 | −1.63212E−11 | 3.71505E−10 | −7.55908E−11 | −1.54175E−10 |
| A11 | −1.82577E−13 | −1.49036E−12 | 3.90669E−11 | 6.11732E−12 | −2.30688E−11 |
| A12 | −2.71477E−14 | −2.87462E−13 | −6.39448E−12 | −9.66037E−13 | 1.28151E−12 |
| A13 | 3.46186E−15 | 5.17533E−14 | −1.99555E−13 | 7.72513E−14 | 2.3111E−13 |
| A14 | −2.72278E−18 | −2.52859E−15 | 7.42065E−14 | 1.11076E−15 | −2.73713E−14 |
| A15 | −6.67053E−18 | 4.08089E−17 | −4.36547E−15 | −3.0215E−16 | 1.20108E−15 |
| A16 | 1.49943E−19 | −8.79931E−21 | 7.94244E−17 | 7.84654E−18 | −2.14997E−17 |

### Example 4-3

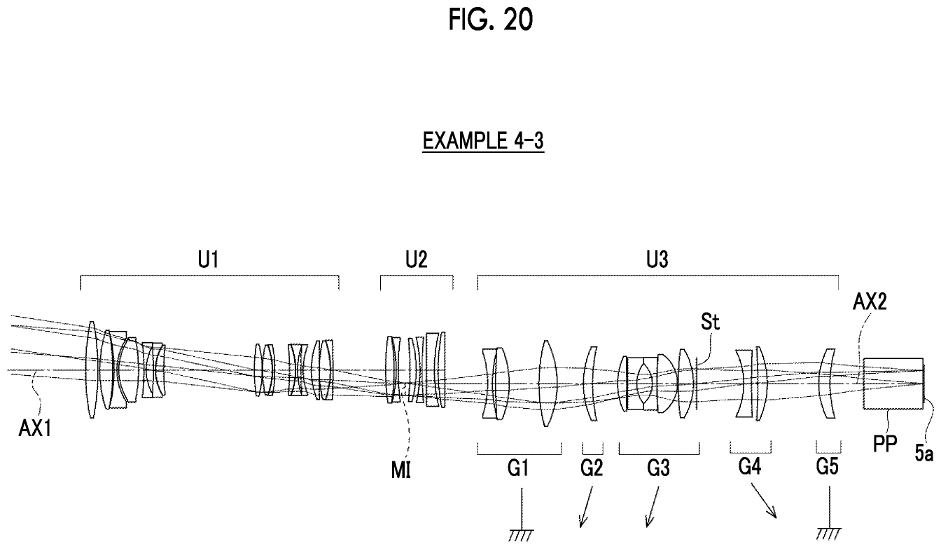

FIG. 20 shows a cross-sectional view of a configuration and luminous flux of an optical device of Example 4-3. The optical device of Example 4-3 includes the first optical system U1, the second optical system U2, and the third optical system U3, in order from the magnification side to the reduction side. The first optical system U1 is the imaging lens of Example 1 described in JP2018-141888A. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 16 lenses. The second optical system U2 consists of six lenses. The third optical system U3 of the optical device of Example 4-3 is common with the third optical system U3 of the optical device of Example 4-1.

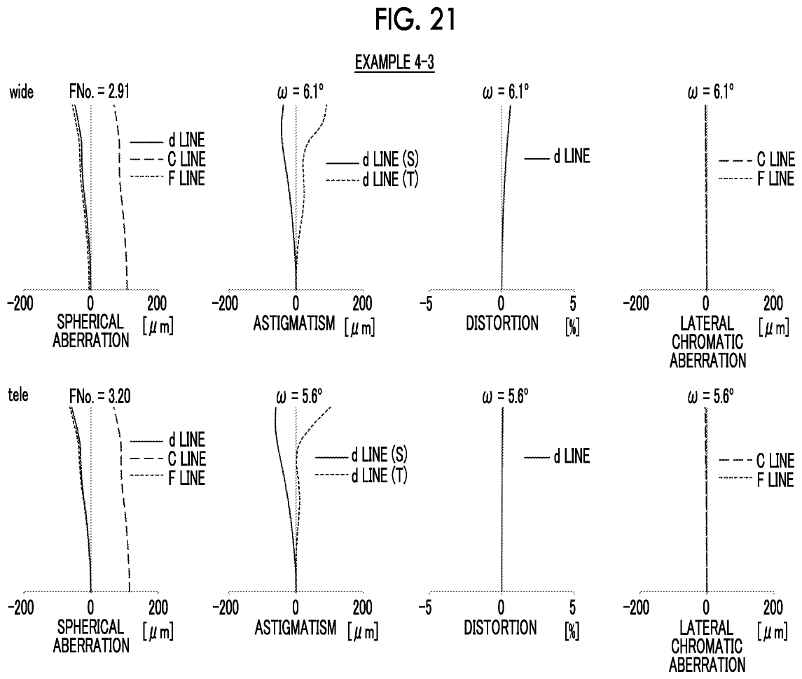

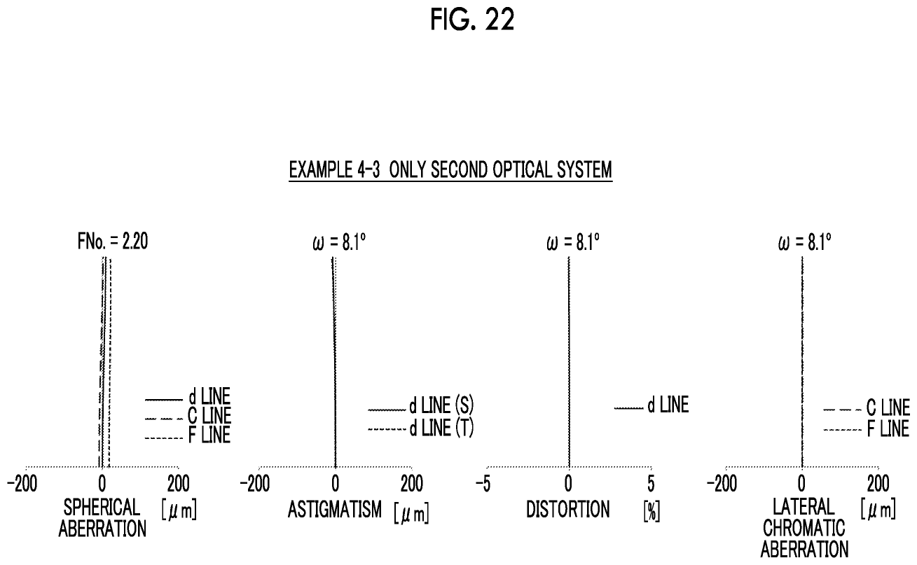

Regarding the optical device of Example 4-3, Tables 16A and 16B show basic lens data, Table 17 shows specifications and variable surface spacing, Table 18 shows aspherical coefficients, and FIG. 21 shows aberration diagrams in a state where the projection distance is infinite. FIG. 22 shows aberration diagrams of only the second optical system U2. The object distance of the second optical system U2 is −7.01 millimeters (mm).

TABLE 16A
Example 4-3

| Sn | R | D | Nd | νd | |
|---|---|---|---|---|---|
| 1 | 119.8423 | 5.44 | 1.72916 | 54.68 | U1 |
| 2 | −119.8423 | 0.8 | | | |
| 3 | 59.8966 | 5.67 | 1.497 | 81.54 | |
| 4 | −101.2948 | 0.71 | | | |
| 5 | −67.2399 | 1.25 | 1.62588 | 35.7 | |
| 6 | 27.2189 | 0.8 | | | |
| *7 | 25.2054 | 8.7 | 1.58313 | 59.46 | |
| *8 | −75.345 | 2.3446 | | | |
| 9 | −115.0082 | 1 | 1.58913 | 61.13 | |
| 10 | 21.8873 | 3.2 | | | |
| 11 | −168.1721 | 0.96 | 1.673 | 38.15 | |
| 12 | 22.32 | 3.54 | 2.00069 | 25.46 | |
| 13 | 95.1317 | 39.9202 | | | |
| 14 | 75.2429 | 3.52 | 1.43875 | 94.66 | |
| 15 | −48.6919 | 0.1 | | | |
| 16 | 51.9815 | 4.34 | 1.497 | 81.54 | |
| 17 | −33.69 | 1.1 | 1.84666 | 23.78 | |
| 18 | −60.0019 | 6.5001 | | | |
| 19 | −94.7357 | 2.57 | 2.00272 | 19.32 | |
| 20 | −33.867 | 0.91 | 1.697 | 48.52 | |
| 21 | 33.867 | 1.56 | | | |
| 22 | 395.2263 | 0.9 | 1.53775 | 74.7 | |
| 23 | 31.3496 | 3.6 | | | |
| 24 | 37.5229 | 3.41 | 1.95375 | 32.32 | |
| 25 | 709.7839 | 0.1 | | | |
| 26 | 59.0208 | 4.9 | 1.5168 | 64.2 | |
| 27 | −43.109 | 1.07 | 1.95906 | 17.47 | |
| 28 | −528.8086 | 23.2571 | | | |
| 29 | 116.8439 | 3.683 | 2.001 | 29.13 | U2 |
| 30 | −98.1505 | 0.9109 | | | |
| 31 | −62.625 | 0.9 | 1.437 | 95.1 | |
| 32 | 111.1093 | 5.2417 | | | |
| 33 | −141.5883 | 2.6984 | 1.83481 | 42.72 | |
| 34 | −54.7889 | 1.6791 | | | |
| 35 | −64.2252 | 0.95 | 1.5927 | 35.31 | |
| 36 | 155.7387 | 1.9534 | | | |
| 37 | 23656.4604 | 3.5 | 1.437 | 95.1 | |
| 38 | 72.123 | 1.7231 | | | |
| 39 | 88.7375 | 2.977 | 2.001 | 29.13 | |
| 40 | ∞ | 18.5199 | | | |

TABLE 16B
Example 4-3

| Sn | R | D | Nd | νd | |
|---|---|---|---|---|---|
| 41 | −48.6352 | 2.1212 | 1.76182 | 26.52 | U3 |
| 42 | 62.9654 | 1.3584 | | | |
| 43 | 267.1389 | 6.0004 | 1.92286 | 20.88 | |
| 44 | −43.7191 | 13.1063 | | | |
| 45 | 78.1151 | 8.0004 | 1.59522 | 67.73 | |
| 46 | −46.4684 | DD[46] | | | |
| 47 | 41.4532 | 3.9992 | 1.80518 | 25.46 | |
| 48 | 76.4252 | DD[48] | | | |
| 49 | 30.2235 | 3.9996 | 1.72916 | 54.68 | |
| 50 | −1533.7002 | 0.4444 | | | |
| 51 | 6530.8583 | 4.0009 | 1.84666 | 23.78 | |
| 52 | 15.7842 | 6.8732 | | | |
| 53 | −12.4913 | 2.0009 | 1.84666 | 23.78 | |
| 54 | 202.2293 | 0.0309 | | | |
| 55 | 189.7227 | 9.0476 | 1.497 | 81.54 | |
| 56 | −16.9226 | 0.3002 | | | |
| 57 | 127.4894 | 6.711 | 1.59522 | 67.73 | |
| 58 | −31.5684 | 1.34 | | | |
| 59(St) | ∞ | DD[59] | | | |
| 60 | −35.0761 | 3.4292 | 1.48749 | 70.24 | |
| 61 | 307.6737 | 2.7715 | | | |
| 62 | −280.2248 | 4.219 | 1.883 | 40.8 | |
| 63 | −41.4744 | DD[63] | | | |
| 64 | 35.364 | 4.9998 | 1.92286 | 20.88 | |
| 65 | 57.9114 | 14.9306 | | | |
| 66 | ∞ | 26 | 1.51633 | 64.14 | |
| 67 | ∞ | 0.48 | | | |

TABLE 17
Example 4-3

| | wide | tele |
|---|---|---|
| Zr | 1 | 1.10 |
| \|f\| | 79.47 | 87.39 |
| FNo. | 2.91 | 3.2 |
| 2ω[°] | 12.2 | 11.2 |
| DD[46] | 11.55 | 4 |
| DD[48] | 11.04 | 14.84 |
| DD[59] | 20.83 | 43.2 |
| DD[63] | 22.61 | 4 |

TABLE 18
Example 4-3

| Sn | 7 | 8 |
|---|---|---|
| KA | 1 | 1 |
| A4 | 3.44168E−06 | −5.63207E−07 |
| A6 | −1.02712E−08 | −7.16945E−09 |
| A8 | 7.8474E−11 | 5.34483E−11 |
| A10 | −1.30127E−12 | −8.25549E−13 |
| A12 | 5.98089E−15 | 2.06905E−15 |
| A14 | 1.56498E−17 | 8.67004E−18 |
| A16 | −3.38711E−19 | −2.12154E−20 |
| A18 | 1.52296E−21 | −2.81331E−22 |
| A20 | −2.52927E−24 | 7.42171E−25 |

### Example 5

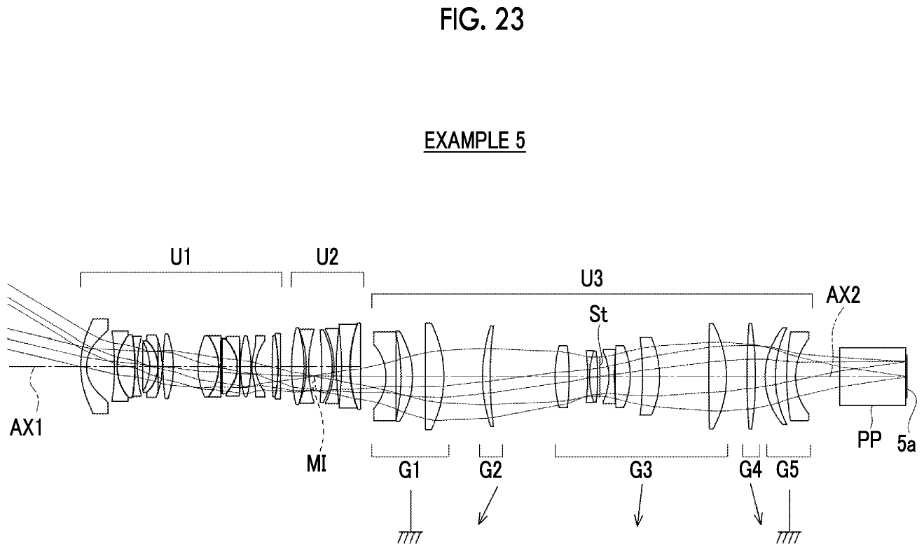

FIG. 23 shows a cross-sectional view of a configuration and luminous flux of an optical device of Example 5. The optical device of Example 5 includes the first optical system U1, the second optical system U2, and the third optical system U3, in order from the magnification side to the reduction side. The first optical system U1 is the imaging lens of Example 1 described in JP2022-16016A. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 15 lenses. The second optical system U2 consists of six lenses. The third optical system U3 consists of 14 lenses and the aperture stop St. The third optical system U3 is a variable magnification optical system. The third optical system U3 consists of, in order from the magnification side to the reduction side, five lens groups, that is, a first lens group G1, a second lens group G2, a third lens group G3, a fourth lens group G4, and a fifth lens group G5. During magnification change, the first lens group G1 and the fifth lens group G5 remain stationary with respect to the image display surface 5a, and the other three lens groups move along the optical axis AX2 by changing the spacing between the adjacent groups.

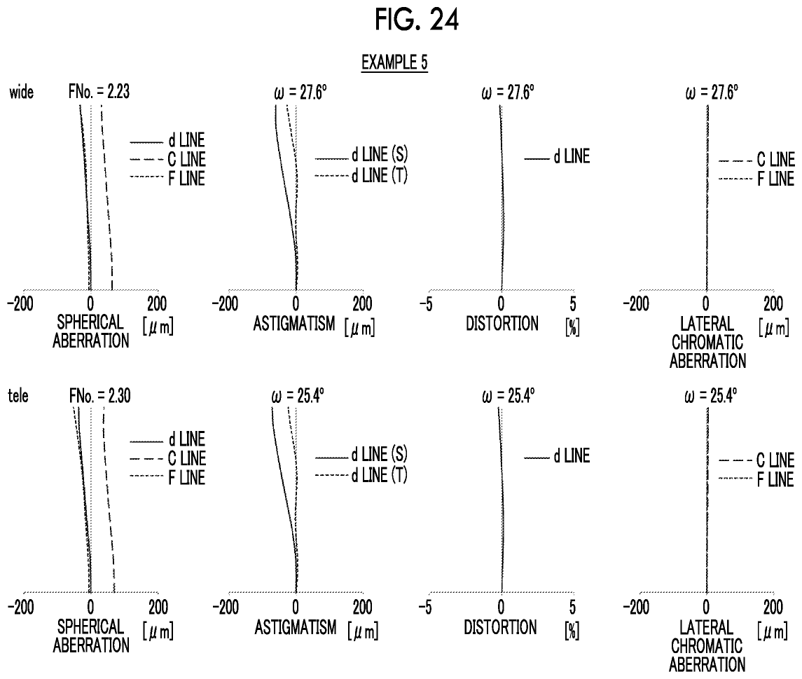

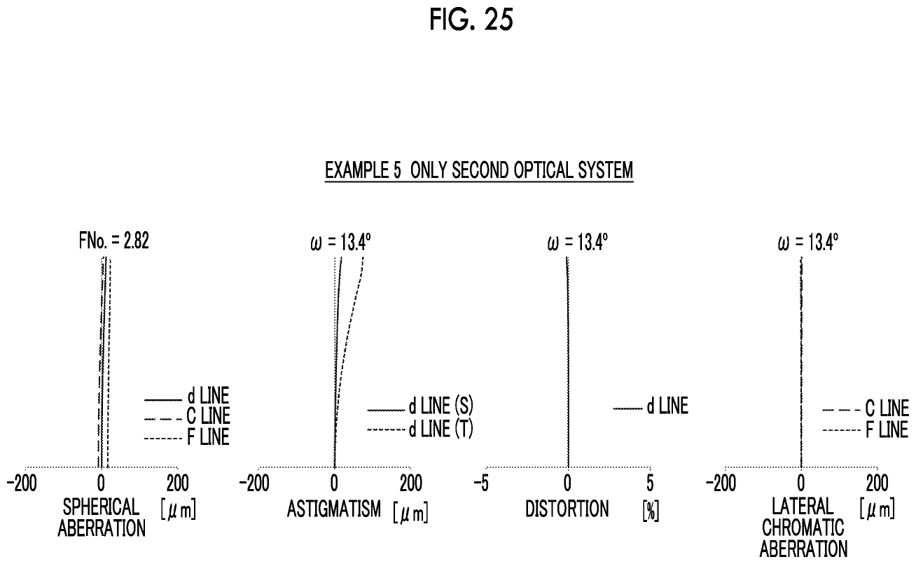

Regarding the optical device of Example 5, Tables 19A and 19B show basic lens data, Table 20 shows specifications and variable surface spacing, Table 21 shows aspherical coefficients, and FIG. 24 shows aberration diagrams in a state where the projection distance is infinite. FIG. 25 shows aberration diagrams of only the second optical system U2. The object distance of the second optical system U2 is −7.01 millimeters (mm).

TABLE 19A
Example 5

| Sn | R | D | Nd | νd | |
|---|---|---|---|---|---|
| *1 | 42.5066 | 2.26 | 1.58313 | 59.46 | U1 |
| *2 | 14.3565 | 11.0287 | | | |
| 3 | −100.1648 | 1.02 | 1.58313 | 59.46 | |
| 4 | 18.6299 | 7.05 | 1.8919 | 37.13 | |
| 5 | −75.498 | 0.97 | 1.48749 | 70.42 | |
| 6 | 42.5062 | 4.8671 | | | |
| *7 | −20.6839 | 3.28 | 1.58254 | 59.44 | |
| 8 | −13.9817 | 1.66 | 2.00069 | 25.43 | |
| 9 | −31.4975 | 0.3 | | | |
| 10 | 89.0372 | 4.11 | 1.95375 | 32.32 | |
| 11 | −38.477 | 9.7174 | | | |
| 12 | 28.6629 | 8.18 | 1.59282 | 68.62 | |
| 13 | −19.7999 | 0.91 | 1.85451 | 25.15 | |
| 14 | ∞ | 0.4007 | | | |
| 15 | ∞ | 5.85 | 1.7725 | 49.61 | |
| 16 | −15.454 | 1.09 | 1.85451 | 25.15 | |
| 17 | −209.9846 | 0.1389 | | | |
| 18 | 45.3596 | 4.16 | 2.00272 | 19.32 | |
| 19 | −45.3596 | 0.4 | | | |
| *20 | 16.1711 | 1.3856 | 1.8061 | 40.73 | |
| *21 | 11.0173 | 6.7182 | | | |
| 22 | 363.2443 | 2.28 | 1.603 | 65.46 | |
| 23 | −62.1067 | 0.92 | 1.84666 | 23.78 | |
| 24 | ∞ | 4.3784 | | | |
| 25 | 63.289 | 5.0011 | 2.001 | 29.13 | U2 |
| 26 | −53.1686 | 0.8717 | | | |
| 27 | −37.8549 | 0.9 | 1.437 | 95.1 | |
| 28 | 48.1168 | 5.2002 | | | |
| 29 | −138.0137 | 4.1075 | 1.83481 | 42.72 | |
| 30 | −30.9753 | 0.6929 | | | |
| 31 | −32.8499 | 0.95 | 1.5927 | 35.31 | |
| 32 | 105.8669 | 2.0291 | | | |
| 33 | −109.6558 | 3.2743 | 1.437 | 95.1 | |
| 34 | 47.4634 | 0.2013 | | | |
| 35 | 50.7169 | 4.0353 | 2.001 | 29.13 | |
| 36 | ∞ | 10.0759 | | | |

TABLE 19B
Example 5

| Sn | R | D | Nd | νd | |
|---|---|---|---|---|---|
| 37 | −19.0393 | 3.9585 | 1.5927 | 35.31 | U3 |
| 38 | ∞ | 1.962 | | | |
| 39 | −73.0867 | 4.5899 | 1.94595 | 17.98 | |
| 40 | −32.5747 | 5.0336 | | | |
| 41 | ∞ | 7.4178 | 1.83481 | 42.72 | |
| 42 | −45.8623 | DD[42] | | | |
| 43 | 62.8123 | 2.9675 | 1.883 | 40.8 | |
| 44 | 149.7608 | DD[44] | | | |
| 45 | 47.8227 | 5.616 | 1.55032 | 75.5 | |
| 46 | −99.642 | 7.2695 | | | |
| 47 | −89.0043 | 0.7491 | 1.94595 | 17.98 | |
| 48 | 30.4925 | 1.0149 | | | |
| 49 | 92.0937 | 2.1798 | 1.61997 | 63.88 | |
| 50 | −92.0937 | 0.8002 | | | |
| 51(St) | ∞ | 3.6517 | | | |
| 52 | −22.6386 | 2.1915 | 1.94595 | 17.98 | |
| 53 | 112.2778 | 0.2996 | | | |
| 54 | 267.2568 | 5.9997 | 1.61997 | 63.88 | |
| 55 | −30.8926 | 4.9087 | | | |
| 56 | −119.0496 | 6.7004 | 1.61997 | 63.88 | |
| 57 | −37.7053 | 19.2457 | | | |
| 58 | 836.1454 | 6.9992 | 1.437 | 95.1 | |
| 59 | −42.6133 | DD[59] | | | |
| 60 | 288.0247 | 3.2726 | 1.94595 | 17.98 | |
| 61 | −148.4147 | DD[61] | | | |
| 62 | 29.4375 | 3.9992 | 2.001 | 29.13 | |
| 63 | 41.8267 | 4.5426 | | | |
| 64 | 100.0001 | 3.5 | 1.5168 | 64.2 | |
| 65 | 23.4342 | 17.4951 | | | |
| 66 | ∞ | 26 | 1.51633 | 64.14 | |
| 67 | ∞ | 0.54 | | | |

TABLE 20
Example 5

| | wide | tele |
|---|---|---|
| Zr | 1 | 1.10 |
| \|f\| | 16.41 | 18.05 |
| FNo. | 2.23 | 2.3 |
| 2ω[°] | 55.2 | 50.8 |
| DD[42] | 15.27 | 3.02 |
| DD[44] | 25.64 | 30.26 |
| DD[59] | 8.1 | 16.57 |
| DD[61] | 3.86 | 3.02 |

TABLE 21
Example 5

| Sn | 1 | 2 | 7 | 20 | 21 |
|---|---|---|---|---|---|
| KA | 3.8510739 | −4.3296751 | −3.0025953 | −5.0000027 | −1.4211109 |
| A3 | 0 | 0 | 0 | 0 | 0 |
| A4 | 8.21013E−05 | 0.000310699 | −5.99947E−05 | −1.56899E−05 | 3.0066E−05 |
| A5 | −9.574E−06 | −1.0193E−05 | 6.16895E−07 | −6.58027E−06 | −1.94313E−05 |
| A6 | 5.95886E−07 | −9.90291E−07 | −1.27982E−06 | −6.92551E−07 | 3.3139E−06 |
| A7 | −3.0456E−08 | 7.41659E−09 | 3.93277E−07 | 1.44799E−08 | −4.37164E−07 |
| A8 | −1.94805E−09 | 5.81716E−09 | −3.45978E−08 | 1.41227E−08 | 2.81052E−08 |
| A9 | 4.08645E−10 | 1.70377E−10 | −2.39255E−09 | −3.49649E−10 | 1.7441E−09 |
| A10 | −1.49197E−11 | −1.63212E−11 | 3.71505E−10 | −7.55908E−11 | −1.54175E−10 |
| A11 | −1.82577E−13 | −1.49036E−12 | 3.90669E−11 | 6.11732E−12 | −2.30688E−11 |
| A12 | −2.71477E−14 | −2.87462E−13 | −6.39448E−12 | −9.66037E−13 | 1.28151E−12 |
| A13 | 3.46186E−15 | 5.17533E−14 | −1.99555E−13 | 7.72513E−14 | 2.3111E−13 |
| A14 | −2.72278E−18 | −2.52859E−15 | 7.42065E−14 | 1.11076E−15 | −2.73713E−14 |
| A15 | −6.67053E−18 | 4.08089E−17 | −4.36547E−15 | −3.0215E−16 | 1.20108E−15 |
| A16 | 1.49943E−19 | −8.79931E−21 | 7.94244E−17 | 7.84654E−18 | −2.14997E−17 |

### Example 6

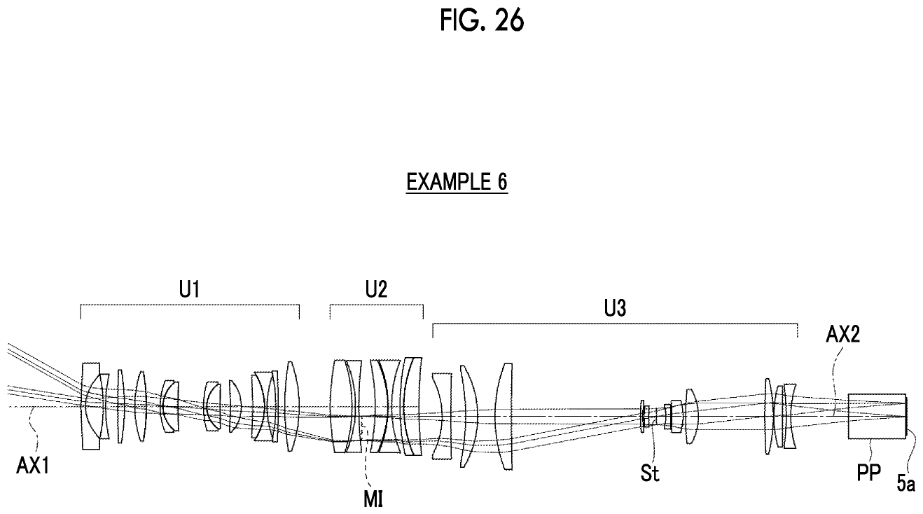

FIG. 26 shows a cross-sectional view of a configuration and luminous flux of an optical device of Example 6. The optical device of Example 6 includes the first optical system U1, the second optical system U2, and the third optical system U3, in order from the magnification side to the reduction side. The first optical system U1 is the imaging lens of Example 1 described in JP2021-117472A. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 13 lenses. The second optical system U2 consists of six lenses. The third optical system U3 consists of 11 lenses and the aperture stop St.

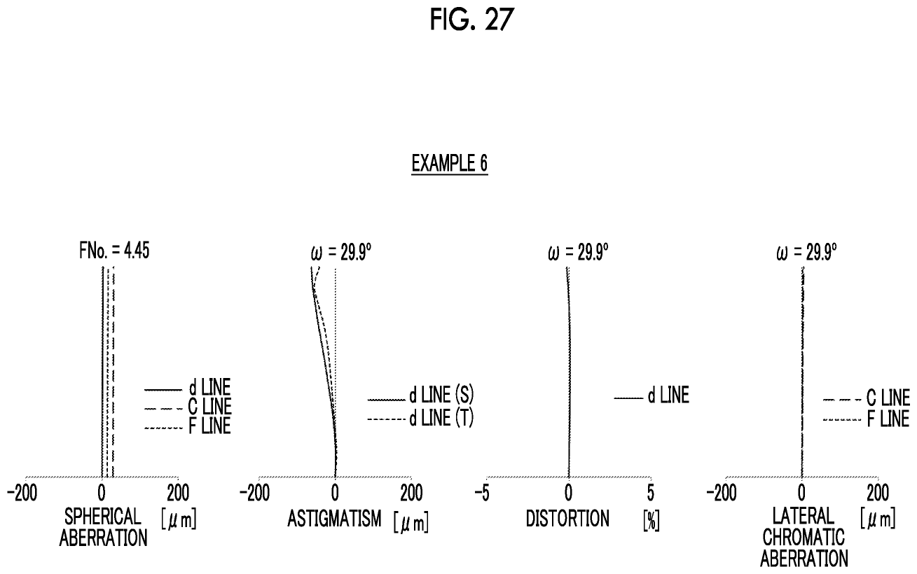

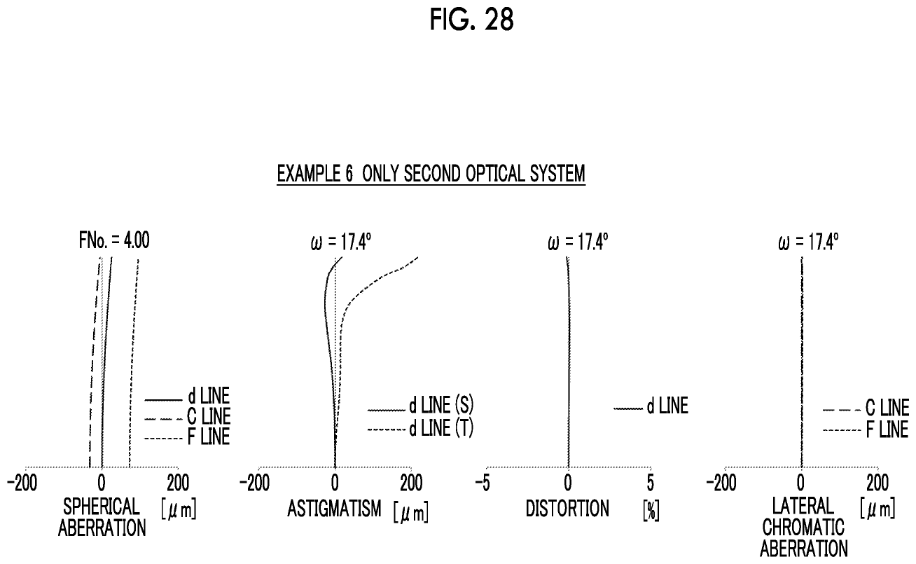

Regarding the optical device of Example 6, Tables 22A and 22B show basic lens data, Table 23 shows specifications, Table 24 shows aspherical coefficients, and FIG. 27 shows aberration diagrams in a state where the projection distance is infinite. FIG. 28 shows aberration diagrams of only the second optical system U2. The object distance of the second optical system U2 is −8.91 millimeters (mm).

TABLE 22A
Example 6

| Sn | R | D | Nd | νd | |
|---|---|---|---|---|---|
| *1 | 131.2588 | 2 | 1.85108 | 40.12 | U1 |
| *2 | 16.6936 | 8.02 | | | |
| 3 | −66.8654 | 1.07 | 1.497 | 81.59 | |
| 4 | 66.8654 | 5.45 | | | |
| 5 | 438.5292 | 3.05 | 1.7847 | 26.29 | |
| 6 | −99.1927 | 4.69 | | | |
| 7 | 49.0218 | 5.25 | 1.7859 | 44.21 | |
| 8 | −89.7385 | 6.19 | | | |
| 9 | 30.2674 | 1.29 | 1.79952 | 42.25 | |
| 10 | 13.865 | 6.75 | 1.62299 | 58.16 | |
| 11 | 179.2836 | 11.56 | | | |
| 12 | 38.6448 | 1.5 | 1.95375 | 32.32 | |
| 13 | 12.429 | 5.99 | 1.497 | 81.59 | |
| 14 | 348.9318 | 4.67 | | | |
| *15 | −153.0689 | 4.68 | 1.58135 | 59.38 | |
| *16 | −18.2765 | 5.22 | | | |
| 17 | −161.7627 | 5.34 | 2.00272 | 19.32 | |
| 18 | −28.43 | 1.21 | 1.738 | 32.33 | |
| 19 | 42.001 | 3.9 | | | |
| 20 | −67.5416 | 1.02 | 1.94595 | 17.98 | |
| 21 | −425.6597 | 3.05 | | | |
| 22 | 125.0308 | 6.5 | 1.56883 | 56.06 | |
| 23 | −60.3989 | 14.0062 | | | |
| 24 | 105.514 | 9.8587 | 2.001 | 29.13 | U2 |
| 25 | −68.622 | 1.5674 | | | |
| 26 | −53.9344 | 1.4999 | 1.437 | 95.1 | |
| 27 | 179.0608 | 7.3985 | | | |
| 28 | −97.5586 | 5.6457 | 2.001 | 29.13 | |
| 29 | −48.901 | 0.2298 | | | |
| 30 | −53.1228 | 1.6 | 1.5927 | 35.31 | |
| 31 | 58.4484 | 3.6987 | | | |
| 32 | 103.0331 | 1.715 | 1.437 | 95.1 | |
| 33 | 55.5622 | 6.8536 | 2.001 | 29.13 | |
| 34 | 195.6947 | 10.5846 | | | |

TABLE 22B
Example 6

| Sn | R | D | Nd | νd | |
|---|---|---|---|---|---|
| 35 | −36.6613 | 3.9489 | 1.48749 | 70.44 | U3 |
| 36 | 748.0417 | 6.6654 | | | |
| 37 | −97.3372 | 5.4286 | 1.94595 | 17.98 | |
| 38 | −45.452 | 7.8434 | | | |
| 39 | 67.7237 | 7.3864 | 2.001 | 29.13 | |
| 40 | 888.1907 | 58.4478 | | | |
| 41 | 85.3259 | 0.9801 | 1.94595 | 17.98 | |
| 42 | 22.4865 | 0.6127 | | | |
| 43 | 29.0303 | 2.1162 | 1.883 | 40.8 | |
| 44 | 75.0801 | 3.5524 | | | |
| 45(St) | ∞ | 4.207 | | | |
| 46 | −15.3336 | 2.1074 | 1.94595 | 17.98 | |
| 47 | 266.2112 | 0.4852 | | | |
| 48 | −161.31 | 5.1427 | 1.8042 | 46.5 | |
| 49 | −24.8581 | 1.1618 | | | |
| 50 | 118.3121 | 5.5268 | 1.55032 | 75.5 | |
| 51 | −25.5488 | 30.0148 | | | |
| 52 | 282.2034 | 3.8448 | 1.94595 | 17.98 | |
| 53 | −71.3177 | 0.2991 | | | |
| 54 | 54.0697 | 3.9407 | 2.001 | 29.13 | |
| 55 | 2264.8782 | 1.5699 | | | |
| 56 | −104.2353 | 2.0954 | 1.5927 | 35.31 | |
| 57 | 46.1733 | 26.0357 | | | |
| 58 | ∞ | 26 | 1.51633 | 64.14 | |
| 59 | ∞ | 0.4868 | | | |

TABLE 23
Example 6

| | |
|---|---|
| \|f\| | 14.9 |
| FNo. | 4.45 |
| 2ω[°] | 59.8 |

TABLE 24
Example 6

| Sn | 1 | 2 | 15 | 16 |
|---|---|---|---|---|
| KA | 1 | 1 | 1 | 1 |
| A3 | 0 | 0 | 0 | 0 |
| A4 | −2.88869E−06 | −1.92669E−05 | 1.14264E−10 | 2.12864E−05 |
| A5 | −6.53067E−07 | −6.81363E−07 | −5.74281E−06 | −1.13361E−05 |
| A6 | 2.01274E−08 | −5.13868E−08 | −5.19738E−08 | 3.2649E−06 |
| A7 | 1.39077E−09 | 1.54352E−09 | 2.96352E−07 | −7.1293E−07 |
| A8 | 1.31042E−11 | −1.88231E−10 | −1.82378E−08 | 1.08566E−07 |
| A9 | −2.3166E−12 | 1.2882E−11 | −9.47169E−09 | −4.71334E−09 |
| A10 | −1.5905E−13 | −5.84334E−14 | 8.35984E−10 | −1.94544E−09 |
| A11 | −3.50692E−15 | −9.24618E−14 | 2.14061E−10 | 3.30128E−10 |
| A12 | −4.01125E−17 | 1.15862E−14 | −2.26034E−11 | 1.34228E−12 |
| A13 | −1.34827E−18 | −1.36018E−15 | −2.79336E−12 | −3.78129E−12 |
| A14 | 2.34309E−18 | 2.33962E−17 | 3.2182E−13 | 9.44705E−14 |
| A15 | 7.87387E−20 | 4.62004E−18 | 2.28722E−14 | 3.16636E−14 |
| A16 | 6.06888E−21 | −9.16173E−19 | −2.63326E−15 | −1.70213E−15 |
| A17 | −5.84253E−22 | 7.75557E−20 | −1.05543E−16 | −9.41954E−17 |
| A18 | −6.84123E−23 | −3.52457E−22 | 9.12283E−18 | 6.02891E−18 |
| A19 | 4.741E−24 | −1.73537E−22 | 6.25118E−19 | 2.02666E−19 |
| A20 | −7.16013E−26 | 3.7489E−24 | −3.90513E−20 | −1.21798E−20 |

### Modification Example of Example 6

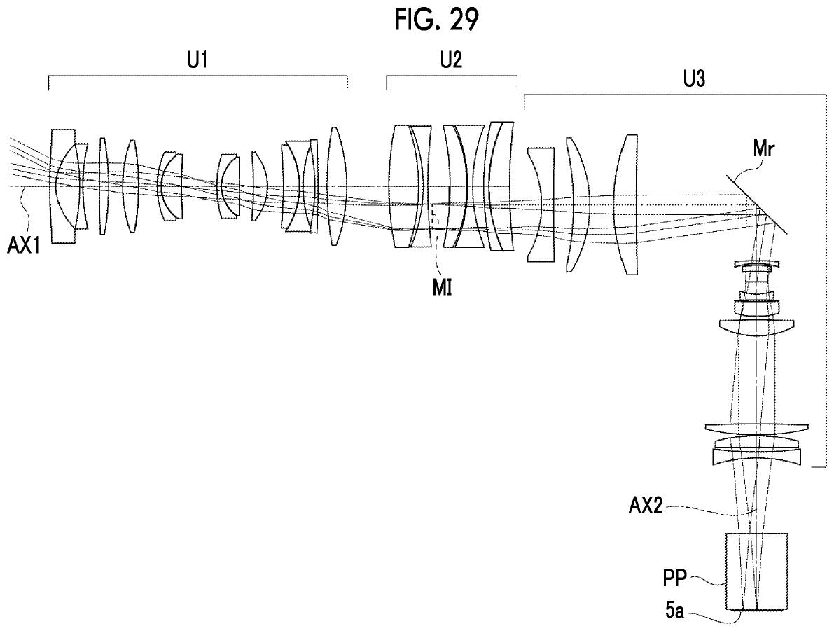

FIG. 29 shows a configuration and luminous flux of an optical device according to a modification example of Example 6. The third optical system U3 of the modification example of FIG. 29 is different from the third optical system U3 of the optical device of Example 6 in that the third optical system U3 includes a mirror Mr which is an optical path deflection member and the optical path is deflected by the mirror Mr. Other configurations of the optical device of FIG. 29 are the same as the configurations of the optical device of Example 6. The spacing between the 40th surface and the mirror Mr on the optical axis is 40 millimeters (mm). By deflecting the optical path, a compact configuration is possible.

### Example 7

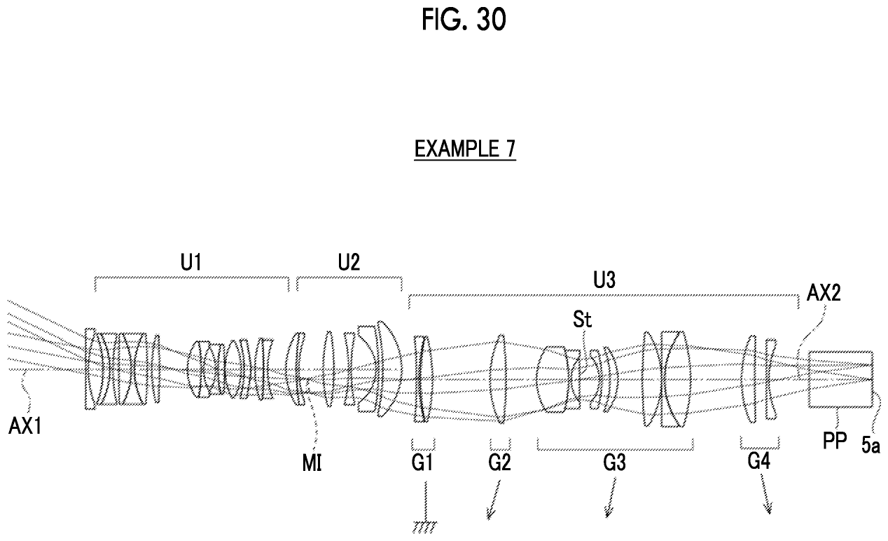

FIG. 30 shows a cross-sectional view of a configuration and luminous flux of an optical device of Example 7. The optical device of Example 7 includes the first optical system U1, the second optical system U2, and the third optical system U3, in order from the magnification side to the reduction side. The first optical system U1 and the second optical system U2 are coaxial systems having the common optical axis AX1. The third optical system U3 is a coaxial system having the common optical axis AX2. The optical axis AX1 and the optical axis AX2 are parallel to each other. The intermediate image MI is formed inside the second optical system U2. The first optical system U1 and the second optical system U2 are housed in different lens barrels. The first optical system U1 and the second optical system U2 can be integrally shifted in the direction parallel to the image display surface 5a.

The first optical system U1 consists of 15 lenses. The second optical system U2 consists of six lenses. The third optical system U3 consists of 12 lenses and the aperture stop St. The third optical system U3 is a variable magnification optical system. The third optical system U3 consists of, in order from the magnification side to the reduction side, four lens groups, that is, a first lens group G1, a second lens group G2, a third lens group G3, and a fourth lens group G4. During magnification change, the first lens group G1 remains stationary with respect to the image display surface 5a, and the other three lens groups move along the optical axis AX2 by changing the spacing between the adjacent groups.

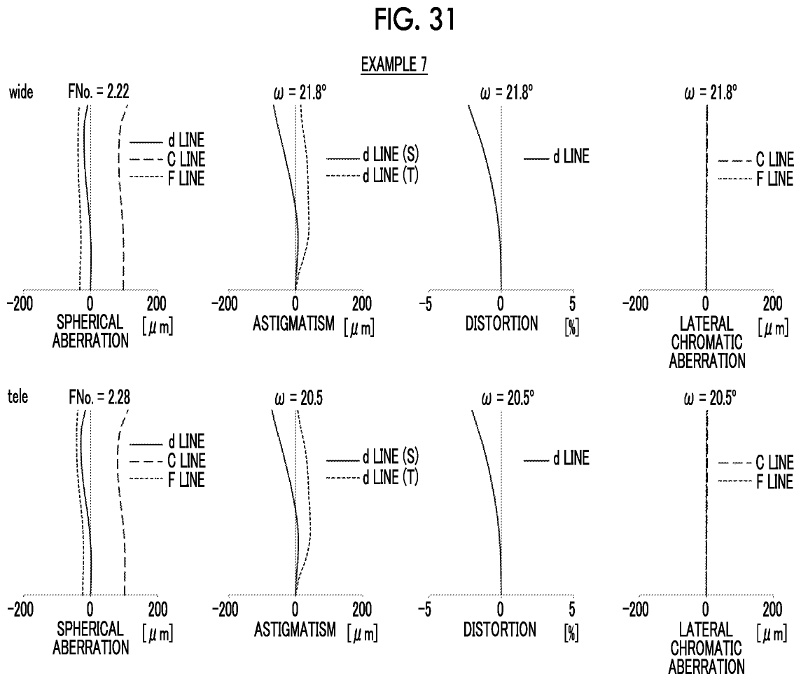

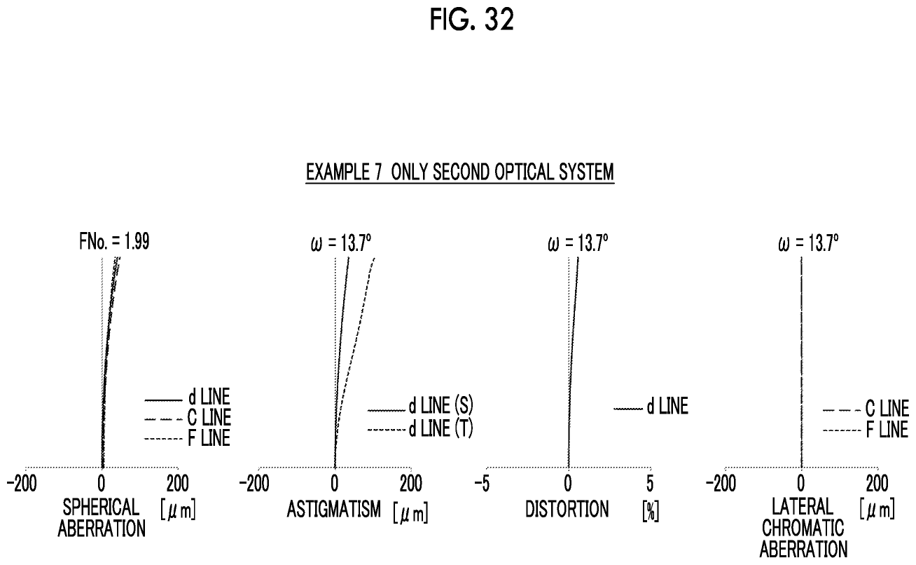

Regarding the optical device of Example 7, Tables 25A and 25B show basic lens data, Table 26 shows specifications and variable surface spacing, Table 27 shows aspherical coefficients, and FIG. 31 shows aberration diagrams in a state where the projection distance is infinite. FIG. 32 shows aberration diagrams of only the second optical system U2. The object distance of the second optical system U2 is −7.03 millimeters (mm).

TABLE 25A
Example 7

| Sn | R | D | Nd | νd | |
|---|---|---|---|---|---|
| 1 | −887.4776 | 1.05 | 1.53996 | 59.73 | U1 |
| 2 | 41.1494 | 6.07 | | | |
| 3 | −41.1494 | 2.9 | 1.883 | 40.8 | |
| 4 | −29.0764 | 1.21 | 1.80809 | 22.76 | |
| 5 | 59.9485 | 2.43 | | | |
| 6 | 383.4806 | 5.21 | 1.883 | 40.8 | |
| 7 | −30.6142 | 1.24 | 1.5927 | 35.31 | |
| 8 | 30.6142 | 5.28 | 1.883 | 40.8 | |
| 9 | −205.8923 | 1.92 | | | |
| 10 | 57.3331 | 3.08 | 1.95906 | 17.47 | |
| 11 | −548.6944 | 11.63 | | | |
| 12 | 20.3442 | 5.7 | 1.59282 | 68.62 | |
| 13 | −62.1811 | 1.01 | 1.53172 | 48.85 | |
| 14 | 19.7263 | 4.9315 | | | |
| 15 | −18.5053 | 0.9 | 1.71736 | 29.51 | |
| 16 | 41.418 | 2.78 | 1.6968 | 55.53 | |
| 17 | −131.9641 | 0.2 | | | |
| 18 | 26.3178 | 6.64 | 1.59282 | 68.62 | |
| 19 | −26.3178 | 1.21 | | | |
| *20 | −47.8136 | 2.75 | 1.8078 | 40.86 | |
| *21 | −29.9011 | 1.75 | | | |
| 22 | 41.9378 | 3.47 | 1.59282 | 68.62 | |
| 23 | −182.0569 | 0.1705 | | | |
| *24 | −96.5919 | 1.6 | 1.68863 | 31.2 | |
| *25 | 39.8918 | 7.5244 | | | |
| 26 | 27.6474 | 4.2917 | 1.8707 | 40.73 | U2 |
| 27 | 87.3869 | 0.0494 | | | |
| 28 | 90.3878 | 1 | 1.71299 | 53.87 | |
| 29 | 38.6759 | 10.0291 | | | |
| 30 | 62.7612 | 4.4956 | 1.90366 | 31.31 | |
| 31 | −88.0451 | 6.0319 | | | |
| 32 | −63.7918 | 1 | 1.48749 | 70.44 | |
| 33 | 67.1031 | 10.3594 | | | |
| 34 | −16.4659 | 1 | 1.59551 | 39.24 | |
| 35 | −97.1179 | 1.7501 | | | |
| 36 | −85.6212 | 7.9218 | 1.7725 | 49.62 | |
| 37 | −27.2345 | 6.0556 | | | |

TABLE 25B
Example 7

| Sn | R | D | Nd | νd | |
|---|---|---|---|---|---|
| 38 | −208.7586 | 1 | 1.80518 | 25.46 | U3 |
| 39 | 67.8061 | 0.6894 | | | |
| 40 | 83.4968 | 4.9263 | 1.92286 | 20.88 | |
| 41 | −72.707 | DD[41] | | | |
| 42 | 42.6151 | 6.5995 | 1.59282 | 68.62 | |
| 43 | −155.6009 | DD[43] | | | |
| 44 | 24.4822 | 13.1506 | 1.6968 | 55.53 | |
| 45 | −49.5252 | 0.0497 | | | |
| 46 | −47.7638 | 0.9991 | 1.84666 | 23.78 | |
| 47 | 13.9461 | 3.5 | | | |
| 48(St) | ∞ | 8.2037 | | | |
| 49 | −14.4571 | 1 | 1.62004 | 36.26 | |
| 50 | −45.1263 | 3.3636 | | | |
| 51 | −36.8233 | 3.2533 | 1.6968 | 55.53 | |
| 52 | −22.7342 | 10.1147 | | | |
| 53 | 179.1455 | 7.9572 | 1.59282 | 68.62 | |
| 54 | −36.4769 | 0.0501 | | | |
| 55 | 4061.312 | 1.1 | 1.64769 | 33.79 | |
| 56 | 32.4885 | 0.145 | | | |
| 57 | 32.9776 | 10.698 | 1.497 | 81.61 | |
| 58 | −63.8359 | DD[58] | | | |
| 59 | 45.0207 | 5.4341 | 1.92286 | 20.88 | |
| 60 | 473.701 | 4.8264 | | | |
| 61 | ∞ | 1 | 1.5168 | 64.2 | |
| 62 | 36.0714 | DD[62] | | | |
| 63 | ∞ | 26 | 1.5168 | 64.2 | |
| 64 | ∞ | 0 | | | |

TABLE 26
Example 7

| | wide | tele |
|---|---|---|
| Zr | 1 | 1.07 |
| \|f\| | 21.87 | 23.4 |
| FNo. | 2.22 | 2.28 |
| 2ω[°] | 43.6 | 41 |
| DD[41] | 23.52 | 17.3 |
| DD[43] | 12.66 | 13.33 |
| DD[58] | 21.08 | 27.17 |
| DD[62] | 16.65 | 16.08 |

TABLE 27
Example 7

| Sn | 20 | 21 | 24 | 25 |
|---|---|---|---|---|
| KA | 1 | 1 | 1 | 1 |
| A3 | 0 | 0 | 0 | 0 |
| A4 | −2.58897E−05 | 3.83181E−05 | 7.23649E−06 | −2.73961E−05 |
| A5 | −1.29825E−05 | −2.49E−05 | 5.02391E−06 | 3.67469E−05 |
| A6 | 3.96745E−06 | 6.2636E−06 | −2.18324E−07 | −1.01919E−05 |
| A7 | −3.33032E−07 | −3.80485E−07 | −2.73555E−07 | 1.12811E−06 |
| A8 | −3.63391E−08 | −7.24063E−08 | 3.95405E−08 | −5.49779E−09 |
| A9 | 8.35078E−09 | 1.16708E−08 | 1.07272E−09 | −1.0848E−08 |
| A10 | −8.88654E−11 | 5.63034E−11 | −4.47593E−10 | 1.02468E−09 |
| A11 | −6.18245E−11 | −8.98287E−11 | 1.20862E−11 | −1.87752E−11 |
| A12 | 2.49789E−12 | 2.88559E−12 | 1.41541E−12 | −3.35991E−12 |
| A13 | 1.54328E−13 | 2.26871E−13 | −6.69876E−14 | 2.74967E−13 |
| A14 | −8.60654E−15 | −1.12789E−14 | 1.62591E−17 | −6.89344E−15 |

Table 28 shows values relating to Conditional Expressions (1) to (5) of the above-mentioned examples. “E-n” (n: integer) in Table 28 means “×10⁻ⁿ”. Table 29 shows the corresponding values of Conditional Expressions (1) to (5) of the above-mentioned examples. Table 28 and Table 29 show values in a case where the d line is used as a reference. Preferable ranges of the conditional expressions may be set by using the corresponding values of the examples shown in Table 29 as the upper limits or the lower limits of the conditional expressions.

TABLE 28

| | Example 1 | Example 2 | Example 3 | Example 4-1 | Example 4-2 |
|---|---|---|---|---|---|
| β | −0.926 | −0.926 | 1.046 | −0.914 | −0.956 |
| sin\|θ\| | 9.26E−02 | 9.26E−02 | 1.05E−01 | 8.89E−02 | 9.30E−02 |
| β2 | −0.926 | −0.926 | 1.046 | 0.889 | 0.930 |
| DU2 | 164.5 | 186.1 | 13.00 | 34.96 | 26.07 |
| Σ(1/(Ni × fi)) | 2.17E−03 | 2.03E−03 | 1.75E−03 | 2.29E−03 | 2.68E−04 |
| Sr ×1000 | 10.13 | −25.54 | −29.96 | 1.750 | 37.43 |
| Tr ×1000 | 184.4 | 94.26 | 120.3 | 125.9 | 159.6 |
| Ymax | 13.15 | 13.15 | 15.07 | 12.64 | 13.20 |

| | Example 4-3 | Example 5 | Example 6 | Example 7 |
|---|---|---|---|---|
| β | −1.009 | −0.917 | −0.483 | −0.926 |
| sin\|θ\| | 9.81E−02 | 9.48E−02 | 9.28E−02 | 9.27E−02 |
| β2 | 0.981 | 0.948 | 0.928 | 0.927 |
| DU2 | 26.22 | 27.26 | 40.07 | 47.93 |
| Σ(1/(Ni × fi)) | 9.28E−05 | −1.24E−04 | 4.05E−04 | 1.33E−03 |
| Sr ×1000 | −7.627 | 17.28 | 17.95 | 35.59 |
| Tr ×1000 | −9.743 | 73.88 | 219.9 | 103.4 |
| Ymax | 13.88 | 13.45 | 25.35 | 13.24 |

TABLE 29

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4-1 | ple 4-2 | ple 4-3 | ple 5 | ple 6 | ple 7 |
| Expression (1) | \|β\| | 0.926 | 0.926 | 1.046 | 0.914 | 0.956 | 1.009 | 0.917 | 0.483 | 0.926 |
| Expression (2) | \|{sin\|θ\|/(\|β2\| × 0.1) − 1} × 100\| | 0.002 | 0.003 | 0.068 | 0.017 | 0.030 | 0.003 | 0.017 | 0.039 | 0.016 |
| Expression (3) | DU2 × \|Σ(1/(Ni × fi))\| | 0.358 | 0.378 | 0.023 | 0.080 | 0.007 | 0.002 | 0.003 | 0.016 | 0.064 |
| Expression (4) | {(Sr + Tr)/2} × 1000/Ymax | 7.397 | 2.613 | 2.997 | 5.049 | 7.464 | −0.626 | 3.389 | 4.691 | 5.25 |
| Expression (5) | \|Sr − Tr\| × 1000/Ymax | 13.255 | 9.11 | 9.97 | 9.821 | 9.256 | 0.152 | 4.208 | 7.967 | 5.125 |

In all of the optical devices of the above-mentioned examples, a non-telecentric lens such as a commercially available lens can be used as the first optical system U1, and the optical device has a lens shift function. Further, as can be seen from the aberration diagram of only the second optical system U2, performance of each of the second optical systems U2 of the above-mentioned examples is ensured by the second optical system U2 alone.

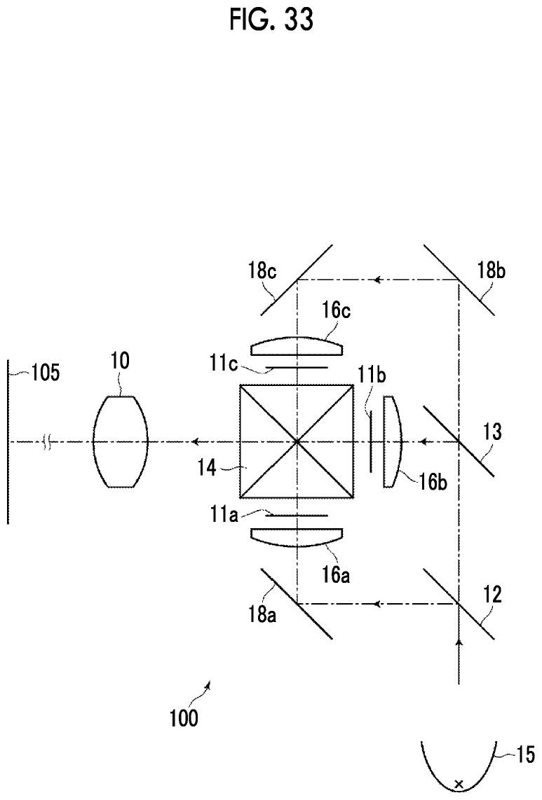

Next, a projection type display apparatus according to an embodiment of the present disclosure will be described. FIG. 33 is a schematic configuration diagram of the projection type display apparatus according to the embodiment of the present disclosure. The projection type display apparatus 100 shown in FIG. 33 has an optical device 10 according to an embodiment of the present disclosure, a light source 15, and transmissive display elements 11a to 11c as light valves corresponding to each color light and outputting an optical image. Further, the projection type display apparatus 100 has dichroic mirrors 12 and 13 for color separation, cross dichroic prisms 14 for color synthesis, condenser lenses 16a to 16c, and total reflection minors 18a to 18c for deflecting an optical path. It should be noted that FIG. 33 schematically shows the optical device 10. Further, an integrator is disposed between the light source 15 and the dichroic mirror 12, but is not shown in FIG. 33.

White light originating from the light source 15 is separated into ray with three colors (green light, blue light, and red light) through the dichroic mirrors 12 and 13. Thereafter, the ray respectively pass through the condenser lenses 16a to 16c, are incident into and modulated through the transmissive display elements 11a to 11c respectively corresponding to the ray with the respective colors, are subjected to color synthesis through the cross dichroic prism 14, and are subsequently incident into the optical device 10. The optical device 10 projects an optical image, which is based on the modulated light modulated through the transmissive display elements 11a to 11c, onto a screen 105.

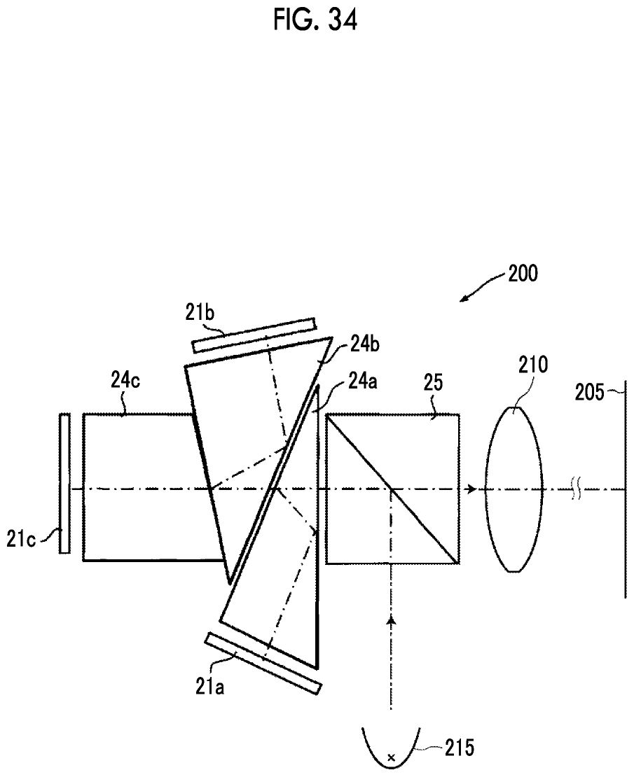

FIG. 34 is a schematic configuration diagram of a projection type display apparatus according to another embodiment of the present disclosure. The projection type display apparatus 200 shown in FIG. 34 has an optical device 210 according to an embodiment of the present disclosure, a light source 215, and digital micromirror device (DMD: registered trademark) elements 21a to 21c as light valves each of which outputs an optical image corresponding to each color light. Further, the projection type display apparatus 200 has total internal reflection (TIR) prisms 24a to 24c for color separation and color synthesis, and a polarized light separating prism 25 that separates illumination light and projection light. It should be noted that FIG. 34 schematically shows the optical device 210. Further, an integrator is disposed between the light source 215 and the polarized light separating prism 25, but is not shown in FIG. 34.

White light originating from the light source 215 is reflected on a reflective surface inside the polarized light separating prism 25, and is separated into ray with three colors (green light, blue light, and red light) through the TIR prisms 24a to 24c. The separated ray with the respective colors are respectively incident into and modulated through the corresponding DMD elements 21a to 21c, travel through the TIR prisms 24a to 24c again in a reverse direction, are subjected to color synthesis, are subsequently transmitted through the polarized light separating prism 25, and are incident into the optical device 210. The optical device 210 projects an optical image, which is based on the modulated light modulated through the DMD elements 21a to 21c, onto a screen 205.

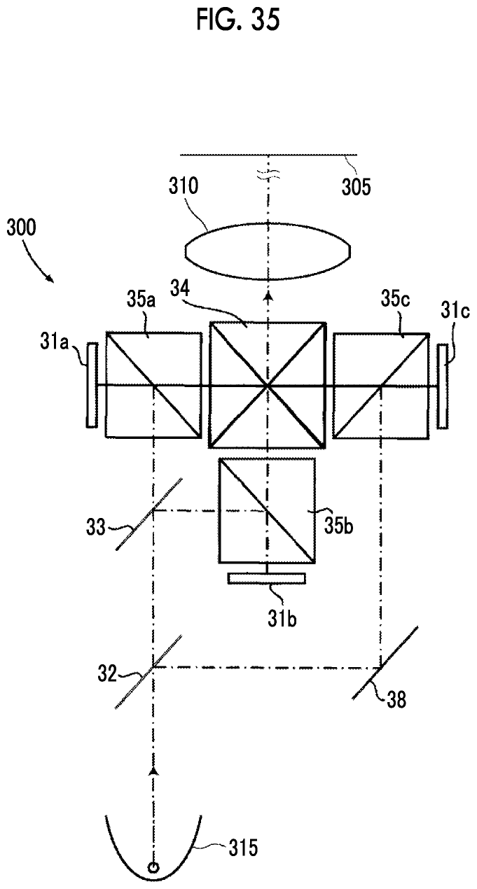

FIG. 35 is a schematic configuration diagram of a projection type display apparatus according to still another embodiment of the present disclosure. The projection type display apparatus 300 shown in FIG. 35 has an optical device 310 according to an embodiment of the present disclosure, a light source 315, and reflective display elements 31a to 31c as light valves corresponding to each color light and outputting an optical image. Further, the projection type display apparatus 300 has dichroic mirrors 32 and 33 for color separation, a cross dichroic prism 34 for color synthesis, a total reflection mirror 38 for optical path deflection, and polarized light separating prisms 35a to 35c. It should be noted that FIG. 35 schematically shows the optical device 310. Further, an integrator is disposed between the light source 315 and the dichroic minor 32, but is not shown in FIG. 35.

White light originating from the light source 315 is separated into ray with three colors (green light, blue light, and red light) through the dichroic minors 32 and 33. The separated ray with the respective colors respectively pass through the polarized light separating prisms 35a to 35c, are incident into and modulated through the reflective display elements 31a to 31c respectively corresponding to the ray with the respective colors, are subjected to color synthesis through the cross dichroic prism 34, and are subsequently incident into the optical device 310. The optical device 310 projects an optical image, which is based on the modulated light modulated through the reflective display elements 31a to 31c, onto a screen 305.

The technique of the present disclosure has been hitherto described through embodiments and examples, but the technique of the present disclosure is not limited to the above-mentioned embodiments and examples, and may be modified into various forms without departing from the spirit of the technique of the present disclosure. For example, the number of lenses included in each optical system, the number of lens groups included in the variable magnification optical system, and the number of lenses included in each lens group may be different from the numbers in the above-mentioned examples. Further, values such as the curvature radius, the surface spacing, the refractive index, the Abbe number, and the aspherical coefficient of each lens are not limited to the values shown in the examples, and different values may be used therefor.

Further, the projection type display apparatus according to the technique of the present disclosure is not limited to the above-mentioned configuration, and may be modified into various forms such as the optical member used for ray separation or ray synthesis and the light valve. The light valve is not limited to a form in which light from a light source is spatially modulated through an image display element and is output as an optical image based on image data, but may be a form in which light itself output from the self-light-emitting image display element is output as an optical image based on the image data. Examples of the self-light-emitting image display element include an image display element in which light emitting elements such as light emitting diodes (LED) or organic light emitting diodes (OLED) are two-dimensionally arranged.

Regarding the above-mentioned embodiments and examples, the following Supplementary Notes will be further disclosed.

Supplementary Note 1

An optical device that projects an image, which is displayed on an image display surface on a reduction side, to a magnification side, the optical device comprising:
a first optical system; and a second optical system, in order from the magnification side to the reduction side along an optical path,
in which the first optical system is an image forming optical system which is not telecentric on the reduction side,
the second optical system is telecentric on the reduction side,
the first optical system is housed in a first lens barrel, and the second optical system is housed in a second lens barrel, and
an optical system on the optical path from a surface closest to the magnification side in the first optical system to a surface closest to the reduction side in the second optical system is shift-able with respect to the image display surface.

Supplementary Note 2

The optical device according to Supplementary Note 1, in which the first optical system and the second optical system are coaxial systems having a common first optical axis.

Supplementary Note 3

The optical device according to Supplementary Note 1 or 2, in which the first optical system is configured to be interchangeable.

Supplementary Note 4

The optical device according to any one of Supplementary Notes 1 to 3,
in which the optical system between the first optical system and the image display surface is only the second optical system, and
an intermediate image is formed closer to the reduction side than the first optical system.

Supplementary Note 5

The optical device according to any one of Supplementary Notes 1 to 4, in which the second optical system includes a group that moves by changing a spacing between adjacent groups during magnification change.

Supplementary Note 6

The optical device according to any one of Supplementary Notes 1 to 3,
in which the optical system between the first optical system and the image display surface is only the second optical system, and
a principal ray with a maximum angle of view incident on the optical device from the image does not intersect with the first optical axis at a position closer to the reduction side than a surface closest to the reduction side in the first optical system.

Supplementary Note 7

The optical device according to any one of Supplementary Notes 1 to 3, further comprising:
a third optical system on the optical path closer to the reduction side than the second optical system,
in which the third optical system is a coaxial system having a second optical axis,
the first optical axis and the second optical axis are parallel to each other, and
an intermediate image is formed closer to the reduction side than the first optical system.

Supplementary Note 8

The optical device according to Supplementary Note 7, in which the intermediate image is formed between a surface closest to the magnification side in the second optical system and the surface closest to the reduction side in the second optical system.

Supplementary Note 9

The optical device according to Supplementary Note 7 or 8,
in which the third optical system is housed in a third lens barrel, and
the second optical system is configured to be interchangeable.

Supplementary Note 10

The optical device according to any one of Supplementary Notes 7 to 9, in which the third optical system includes a group that moves by changing a spacing between adjacent groups during magnification change.

Supplementary Note 11

The optical device according to any one of Supplementary Notes 1 to 10, in which assuming that a combined lateral magnification of an entire optical system between the first optical system and the image display surface is β,
where β is a value in a case where the magnification side is an object side and the reduction side is an image side, and
β is a value at a wide angle end in a case where the optical device includes a variable magnification optical system,

Conditional Expression (1) is satisfied, which is represented by

0.25<|β|<2 (1).

Supplementary Note 12

The optical device according to any one of Supplementary Notes 1 to 11, in which assuming that
an on-axis ray of which an angle θ1 with an optical axis satisfies sin θ1=0.1 in an air spacing adjacent to the reduction side in the second optical system is a first on-axis ray,
an angle between the first on-axis ray and the optical axis in an air spacing adjacent to the magnification side in the second optical system is θ,
a lateral magnification of the second optical system is β2,
   where β2 is a value in a case where the magnification side is an object side and the reduction side is an image side,
a total number of lenses included in the second optical system is k,
a natural number from 1 to k is i,
a refractive index of an i-th lens of the second optical system at a d line from the magnification side is Ni,
a focal length of the i-th lens of the second optical system from the magnification side is fi, and
a distance on the optical axis from a surface closest to the magnification side in the second optical system to the surface closest to the reduction side in the second optical system is DU2,
   where θ, β2, and DU2 are values at a wide angle end in a case where the optical device includes a variable magnification optical system,

Conditional Expressions (2) and (3) are satisfied, which are represented by

$$\vert \{ sin \vert θ \vert ( \vert β2 \vert \times 0.1 ) - 1 \} \times 100 \vert < 0.2 , \qquad ( 2 )$$

$$and$$

$$DU 2 \times \vert {\sum }_{i = 1}^{k} ( \frac{1}{Ni \times fì} ) \vert < 1. \qquad ( 3 )$$

Supplementary Note 13

The optical device according to any one of Supplementary Notes 1 to 12, in which assuming that
a maximum image height on the reduction side in the second optical system is Ymax,
a distance to a sagittal image plane at the maximum image height of the second optical system with respect to a paraxial image formation position on the reduction side in the second optical system as an origin in a direction of optical axis is Sr, and
a distance to a tangential image plane at the maximum image height of the second optical system with respect to the paraxial image formation position on the reduction side in the second optical system as an origin in the direction of optical axis is Tr,
   where a sign of each distance of Sr and Tr on the magnification side from each origin is negative and a sign of each distance of Sr and Tr on the reduction side from each origin is positive, and
   Sr, Tr, and Ymax are values at a wide angle end in a case where the optical device includes a variable magnification optical system,

Conditional Expressions (4) and (5) are satisfied, which are represented by

−10<{(Sr+Tr)/2}×1000/Ymax<20 (4), and

|Sr−Tr|×1000/Ymax<30 (5).

Supplementary Note 14

The optical device according to Supplementary Note 11, in which Conditional Expression (1-1) is satisfied, which is represented by

0.4<|β|<1.5 (1-1).

Supplementary Note 15

The optical device according to Supplementary Note 12, in which Conditional Expression (2-1) is satisfied, which is represented by

0≤|{sin|θ|/(β2|×0.1)−1}×100|<0.1 (2-1).

Supplementary Note 16

The optical device according to Supplementary Note 12, in which Conditional Expression (3-1) is satisfied, which is represented by

$$0 ≦ DU 2 \times \vert {{\sum }_{i = 1}}^{k} ( \frac{1}{Ni \times fi} ) \vert < 0.5 . \qquad ( 3 - 1 )$$

Supplementary Note 17

The optical device according to Supplementary Note 13, in which Conditional Expression (4-1) is satisfied, which is represented by

0<{(Sr+Tr)/2}×1000/Ymax<10 (4-1).

Supplementary Note 18

The optical device according to Supplementary Note 13, in which Conditional Expression (5-1) is satisfied, which is represented by

0<|Sr−Tr|×1000/Ymax<20 (5-1).

Supplementary Note 19

A projection type display apparatus comprising:
a light valve that outputs the image; and
the optical device according to any one of Supplementary Notes 1 to 18.

Supplementary Note 20

An optical system incorporated in an optical device that projects an image, which is displayed on an image display surface on a reduction side, to a magnification side,
in which the optical system is disposed on an optical path on the reduction side of an image forming optical system which is not telecentric on the reduction side and is housed in a first lens barrel,
the optical system is telecentric on the reduction side,
the optical system is housed in a second lens barrel, and
the optical system is shift-able integrally with the image forming optical system with respect to the image display surface.

What is claimed is:

1. An optical device that projects an image, which is displayed on an image display surface on a reduction side, to a magnification side, the optical device comprising:
a first optical system; and a second optical system, in order from the magnification side to the reduction side along an optical path,
wherein the first optical system is an image forming optical system which is not telecentric on the reduction side,
the second optical system is telecentric on the reduction side,
the first optical system is housed in a first lens barrel, and the second optical system is housed in a second lens barrel, and
an optical system on the optical path from a surface closest to the magnification side in the first optical system to a surface closest to the reduction side in the second optical system is shift-able with respect to the image display surface.

2. The optical device according to claim 1, wherein the first optical system and the second optical system are coaxial systems having a common first optical axis.

3. The optical device according to claim 2, wherein the first optical system is configured to be interchangeable.

4. The optical device according to claim 2,
wherein the optical system between the first optical system and the image display surface is only the second optical system, and
an intermediate image is formed closer to the reduction side than the first optical system.

5. The optical device according to claim 4, wherein the second optical system includes a group that moves by changing a spacing between adjacent groups during magnification change.

6. The optical device according to claim 2,
wherein the optical system between the first optical system and the image display surface is only the second optical system, and
a principal ray with a maximum angle of view incident on the optical device from the image does not intersect with the first optical axis at a position closer to the reduction side than a surface closest to the reduction side in the first optical system.

7. The optical device according to claim 2, further comprising:
a third optical system on the optical path closer to the reduction side than the second optical system,
wherein the third optical system is a coaxial system having a second optical axis,
the first optical axis and the second optical axis are parallel to each other, and
an intermediate image is formed closer to the reduction side than the first optical system.

8. The optical device according to claim 7, wherein the intermediate image is formed between a surface closest to the magnification side in the second optical system and the surface closest to the reduction side in the second optical system.

9. The optical device according to claim 7,
wherein the third optical system is housed in a third lens barrel, and
the second optical system is configured to be interchangeable.

10. The optical device according to claim 7, wherein the third optical system includes a group that moves by changing a spacing between adjacent groups during magnification change.

11. The optical device according to claim 1, wherein assuming that a combined lateral magnification of an entire optical system between the first optical system and the image display surface is β,
where β is a value in a case where the magnification side is an object side and the reduction side is an image side, and
β is a value at a wide angle end in a case where the optical device includes a variable magnification optical system,
Conditional Expression (1) is satisfied, which is represented by
0.25<|β|<2 (1).

12. The optical device according to claim 1, wherein assuming that
an on-axis ray of which an angle θ1 with an optical axis satisfies sin θ1=0.1 in an air spacing adjacent to the reduction side in the second optical system is a first on-axis ray,
an angle between the first on-axis ray and the optical axis in an air spacing adjacent to the magnification side in the second optical system is θ,
a lateral magnification of the second optical system is β2,
where β2 is a value in a case where the magnification side is an object side and the reduction side is an image side,
a total number of lenses included in the second optical system is k,
a natural number from 1 to k is i,
a refractive index of an i-th lens of the second optical system at a d line from the magnification side is Ni,
a focal length of the i-th lens of the second optical system from the magnification side is fi, and
a distance on the optical axis from a surface closest to the magnification side in the second optical system to the surface closest to the reduction side in the second optical system is DU2,
where θ, β2, and DU2 are values at a wide angle end in a case where the optical device includes a variable magnification optical system,
Conditional Expressions (2) and (3) are satisfied, which are represented by
$$\vert \{ sin \vert θ \vert / ( \vert β2 \vert \times 0.1 ) - 1 \} \times 100 \vert < 0.2 , \qquad ( 2 )$$
$$and$$
$$DU 2 \vert {\sum }_{i = 1}^{k} ( \frac{1}{Ni \times fi} ) \vert < 1. \qquad ( 3 )$$

13. The optical device according to claim 1, wherein assuming that
a maximum image height on the reduction side in the second optical system is Ymax,
a distance to a sagittal image plane at the maximum image height of the second optical system with respect to a paraxial image formation position on the reduction side in the second optical system as an origin in a direction of optical axis is Sr, and
a distance to a tangential image plane at the maximum image height of the second optical system with respect to the paraxial image formation position on the reduction side in the second optical system as an origin in the direction of optical axis is Tr,
where a sign of each distance of Sr and Tr on the magnification side from each origin is negative and a sign of each distance of Sr and Tr on the reduction side from each origin is positive, and
Sr, Tr, and Ymax are values at a wide angle end in a case where the optical device includes a variable magnification optical system,
Conditional Expressions (4) and (5) are satisfied, which are represented by
−10<{(Sr+Tr)/2}×1000/Ymax<20 (4), and

|Sr−Tr|×1000/Ymax<30 (5).

14. The optical device according to claim 11, wherein Conditional Expression (1-1) is satisfied, which is represented by
0.4<|β|<1.5 (1-1).

15. The optical device according to claim 12, wherein Conditional Expression (2-1) is satisfied, which is represented by
0≤|{sin|θ|/(β2|×0.1)−1}×100|<0.1 (2-1).

16. The optical device according to claim 12, wherein Conditional Expression (3-1) is satisfied, which is represented by
$$0 ≦ DU 2 \times \vert {\sum }_{i = 1}^{k} ( \frac{1}{Ni \times fi} ) \vert < 0.5 . \qquad ( 3 - 1 )$$

17. The optical device according to claim 13, wherein Conditional Expression (4-1) is satisfied, which is represented by
0<{(Sr+Tr)/2}×1000/Ymax<10 (4-1).

18. The optical device according to claim 13, wherein Conditional Expression (5-1) is satisfied, which is represented by
0<|Sr−Tr|×1000/Ymax<20 (5-1).

19. A projection type display apparatus comprising:
a light valve that outputs the image; and
the optical device according to claim 1.

20. An optical system incorporated in an optical device that projects an image, which is displayed on an image display surface on a reduction side, to a magnification side,
wherein the optical system is disposed on an optical path on the reduction side of an image forming optical system which is not telecentric on the reduction side and is housed in a first lens barrel,
the optical system is telecentric on the reduction side,
the optical system is housed in a second lens barrel, and
the optical system is shift-able integrally with the image forming optical system with respect to the image display surface.
